(19) United States
(12) Patent Application Publication
(10) Pub. No.: US 2026/0097479 A1
(43) Pub. Date: Apr. 9, 2026

(54) JOB-SITE ELECTRIC DEVICE

(71) Applicant: MAKITA CORPORATION, Anjo-shi (JP)

(72) Inventors: Makoto CHIKARAISHI, Anjo-shi (JP); Akihiro YAMADA, Anjo-shi (JP)

(73) Assignee: MAKITA CORPORATION, Anjo-shi (JP)

(21) Appl. No.: 19/351,009

(22) Filed: Oct. 6, 2025

(30) Foreign Application Priority Data
Oct. 7, 2024 (JP) 2024-175947

(51) Int. Cl. B25F 5/02; F21V 33/00

(52) U.S. Cl. CPC B25F 5/02; F21V 33/0084

(57) ABSTRACT

One aspect of the present disclosure provides a job-site electric device including a first switch, a first manually operating member, and a support body. The first switch includes a first movable piece movable in a first direction. The first manually operating member includes a first operating portion and a first arm. The first operating portion is away from the first movable piece in a second direction opposite to the first direction. The first arm includes a first end coupled to the support body and a second end coupled to the first operating portion. The first end is away from a first reference plane in the first direction. The first reference plane is perpendicular to the first direction and passes through the second end. The first operating portion is manually moved in the first direction and thereby applies a first load to the first movable piece.

### CROSS-REFERENCE TO RELATED APPLICATIONS

This application claims the benefit of Japanese Patent Application No. 2024-175947 filed on Oct. 7, 2024 with the Japanese Patent Office, the entire disclosure of which is incorporated herein by reference.

### BACKGROUND

The present disclosure relates to a job-site electric device that includes a switch which is manually operated.

Japanese Patent No. 6400636 discloses an electric power tool that includes a push-button switch. In this electric power tool, a switch part is situated right above the push-button switch. The switch part is pressed by a user of the electric power tool. The push-button switch is operated by the switch part in response to the switch part being pressed.

### SUMMARY

In such an electric power tool, it is desirable that the user can easily operate the push-button switch via the switch part with an appropriate force.

In one aspect of the present disclosure, it is desirable, in a job-site electric device that includes a switch, that the amount of force necessary for a user to operate the switch can be reduced.

In the present disclosure, languages such as “first” and “second” merely intend to distinguish between elements but does not intend to limit the order or the number of the elements. Thus, a first element may be referred to as a second element, and likewise, a second element may be referred to as a first element. In addition, a first element may be included without an inclusion of a second element, and likewise, a second element may be included without an inclusion of a first element. In the present disclosure, an expression of “A, B, . . . and/or Z” (where “A”, “B”, and “Z” are any letters or languages) means “at least one of A, B, . . . or Z”.

One aspect of the present disclosure provides a job-site electric device that includes a first switch, a first manually operating member, and a support body.

The first switch includes a first movable piece. The first movable piece moves in a first direction in response to receiving a first load in the first direction.

The first manually operating member includes a first operating portion and a first arm.

The first operating portion is situated away from the first movable piece in a second direction. The second direction is a direction opposite to the first direction. The first operating portion is displaced in the first direction in response to being manually moved in the first direction and thereby applies the first load to the first movable piece.

The first arm includes a first end and a second end. The second end is coupled to the first operating portion. The first end is situated away from a first reference plane in the first direction in a first initial state. The first initial state corresponds to a state where the first manually operating member is not manually moved. The first reference plane is an imaginary plane that is perpendicular to the first direction and that passes through the second end of the first arm.

The support body is coupled to the first end of the first arm and thereby supports the first manually operating member.

In the job-site electric device configured as described above, the first end of the first arm is situated further in the first direction than the second end of the first arm is. Thus, it is possible to reduce the force required for the user to operate the switch.

### BRIEF DESCRIPTION OF THE DRAWINGS

Example embodiments of the present disclosure will be described hereinafter with reference to the accompanying drawings, in which:

FIG. 1 is a perspective view of a job-site electric device in a first embodiment;

FIG. 2 is an explanatory diagram showing an electric configuration of the job-site electric device in the first embodiment;

FIG. 3 is a perspective view of a switch unit and a controller in the first embodiment;

FIG. 4 is an exploded perspective view of the switch unit in the first embodiment;

FIG. 5 is a perspective view of a switch plate in the first embodiment;

FIG. 6 is a partial top view of the switch unit in the first embodiment;

FIG. 7 is a perspective view of a cross-section taken along a line VII-VII of FIG. 6;

FIG. 8 is a cross-sectional view taken along a line VIII-VIII of FIG. 6;

FIG. 9 is a cross-sectional view taken along the line VIII-VIII in a state where an operating portion is pressed;

FIG. 10 is a perspective view of a job-site electric device in a second embodiment;

FIG. 11 is an explanatory diagram showing an electric configuration of the job-site electric device in the second embodiment;

FIG. 12 is a perspective view of a switch unit and a controller in the second embodiment;

FIG. 13 is an exploded perspective view of the switch unit in the second embodiment;

FIG. 14 is a top view of the switch unit in the second embodiment;

FIG. 15 is a perspective view of a cross section taken along a line XV-XV of FIG. 14;

FIG. 16 is a cross-sectional view taken along a line XVI-XVI of FIG. 14;

FIG. 17 is a cross-sectional view taken along the line XVI-XVI in a state where an operating portion is pressed;

FIG. 18 is a perspective view of a first housing and the switch unit in the second embodiment in an unassembled state;

FIG. 19 is a perspective view of the first housing and the switch unit in the second embodiment in an mid-assembly state where the switch unit is fitted to the first housing;

FIG. 20 is a perspective view for explaining that a second housing can be assembled from the mid-assembly state in the second embodiment;

FIG. 21 is a top view of a switch unit in a third embodiment;

FIG. 22 is an exploded perspective view of the switch unit in the third embodiment;

FIG. 23 is a perspective view of a cross section taken along a line XXIII-XXIII of FIG. 21;

FIG. 24 is an explanatory diagram for explaining structural features of the switch unit in the third embodiment;

FIG. 25 is a top view of a switch unit in a fourth embodiment;

FIG. 26 is an exploded perspective view of the switch unit in the fourth embodiment;

FIG. 27 is a perspective view of a cross section taken along a line XXVII-XXVII of FIG. 25;

FIG. 28 is an explanatory diagram for explaining structural features of the switch unit in the fourth embodiment; and

FIG. 29 is a cross-sectional view showing a modified example of a switch unit.

### DETAILED DESCRIPTION OF EXEMPLARY EMBODIMENTS

### 1. Overview of Embodiments

An embodiment may provide a job-site electric device (or a job-site electric apparatus) that includes at least any one of the following features.
Feature 1: a first switch.
Feature 2: the first switch includes a first movable piece (or a first movable portion, or a first push rod, or a first actuator).
Feature 3: the first movable piece is configured to move in a first direction.
Feature 4: the first movable piece is configured to move in the first direction in response to receiving a first load in the first direction.
Feature 5: a first manually operating member (or a first manually operated portion, or a first manually pressing member). The first manually operating member may be configured to be manually moved by a user of the job-site electric device.
Feature 6: the first manually operating member includes a first operating portion (or a first operating main body, or a first button).
Feature 7: the first operating portion is situated away from the first movable piece in a second direction. The first operating portion may be configured to be manually moved (for example, pressed in the first direction) by the user.
Feature 8: the second direction is opposite to the first direction.
Feature 9: the first operating portion is configured to be displaced in the first direction in response to being manually moved in the first direction.
Feature 10: the first operating portion is configured to be displaced in the first direction in response to being manually moved in the first direction and thereby configured to apply the first load to the first movable piece.
Feature 11: the first manually operating member includes a first arm (or a first arm portion).
Feature 12: the first arm includes a first end.
Feature 13: the first arm includes a second end.
Feature 14: the second end is coupled to the first operating portion.
Feature 15: in a first initial state, the first end is situated away from a first reference plane in the first direction.
Feature 16: the first initial state is a state in which the first manually operating member is not manually moved.
Feature 17: the first reference plane is an imaginary plane that is perpendicular to the first direction and that passes through the second end.
Feature 18: a support body.
Feature 19: the first end of the first arm is coupled to the support body.
Feature 20: the first end of the first arm is coupled to the support body, and thereby the support body supports the first manually operating member.

In the job-site electric device that includes at least Features 1 to 20, the first end of the first arm is situated further in the first direction than the second end of the first arm is. Thus, it is possible to reduce the force necessary for the user to operate the first switch.

The first manually operating member may be configured to be displaced in the first direction in response to the first operating portion being pressed in the first direction. The first operating portion may be configured to come in contact with the first movable piece directly or indirectly to thereby apply the first load to the first movable piece.

The first operating portion may be configured to be manually and directly moved by the user. The first operating portion may be configured to be manually and indirectly moved by the user. Specifically, a first given member (for example, a cover or a film) may be disposed adjacent to the first operating portion on its second direction side. The first given member may be manually moved by the user, and thereby the first operating portion is moved by the first given member. In other words, the first operating portion may be manually and indirectly moved by the user via the first given member.

The first switch may include a first electric contact. The first electric contact may be configured to be closed or opened in response to the first movable piece being moved (or moved for a fixed length or more) in the first direction. The first switch may be configured for so-called momentary operation or may be configured for so-called alternate operation.

In the first initial state, the first movable piece may be situated at a first initial position. The first movable piece may be configured to move (or move for a fixed length or more) in the first direction from the first initial position in response to receiving the first load in the first direction.

The first arm may extend from the first operating portion in any manner. The first arm may have a long and thin plate-like (or a rod-like) shape. A first distance, which is from the first reference plane to the first arm, may vary depending on the position of the first arm. The first distance may increase continuously or intermittently from the second end to the first end of the first arm, for example. There may be a part between the second end and the first end of the first arm where the first distance decreases.

The first end of the first arm may be defined as a boundary from the support body or as a given area or a given position within the boundary. Specifically, the first end of the first arm may be defined as a whole of a connecting surface (that is, a cross section) coupled to the support body or as a given area or a given position within the connecting surface (for example, an end or an intermediate position of the connecting surface in the first direction).

The second end of the first arm may be defined as a boundary from the first operating portion or as a given area or a given position within the boundary. Specifically, the second end of the first arm may be defined as a whole of a connecting surface (that is, a cross section) coupled to the first operating portion or as a given area or a given position within the connecting surface (for example, an end or an intermediate position of the connecting surface in the first direction).

The first operating portion, the first arm, and the support body may be integrally molded. In other words, an integrally molded member which will be mentioned below may include at least two of the first operating portion, the first arm, or the support body.

One embodiment may include at least any one of the following features in addition to or in place of at least any one of Features 1 through 20 mentioned above.
Feature 21: the first movable piece includes a switch surface (i) that corresponds to a surface of the first movable piece and (ii) that is configured to receive the first load from the first operating portion in response to the first operating portion contacting the switch surface.
Feature 22: an arm distal-end distance is greater than or equal to a switch surface distance. The arm distal-end distance is a distance from the first reference plane to the first end of the first arm (or to an edge of the first end in the first direction) along the first direction in the first initial state. The switch surface distance is a distance from the first reference plane to the switch surface along the first direction in the first initial state.

In the job-site electric device that includes at least Features 1 through 22, a vector of a force (i.e., the first load) that is applied from the first operating portion to the switch surface can be made to coincide with or closer to the first direction. Accordingly, it is possible to efficiently apply a force, which is applied from the user to the first operating portion, to the first movable piece.

The switch surface distance may be a distance from the first reference plane to a press position. The press position is a position on the switch surface where the first operating portion contacts the switch surface.

One embodiment may include the following feature in addition to or in place of at least any one of Features 1 through 22 mentioned above.
Feature 23: the first manually operating member is configured to be displaced in the first direction about the first end of the first arm as a fulcrum in response to the first operating portion being manually moved (or pressed) in the first direction.

In the job-site electric device that includes at least Features 1 through 20, and 23, the vector of the force that is applied from the first operating portion to the switch surface can be made to coincide with or closer to the first direction. Accordingly, it is possible to efficiently apply the force, which is applied from the user to the first operating portion, to the first movable piece.

The feature that the first manually operating member is displaced in the first direction about the first end of the first arm as the fulcrum may be alternatively described as the first operating portion being displaced in the first direction about the first end of the first arm as the fulcrum.

The direction in which the first operating portion moves at the moment a load begins to be applied from the first operating portion to the first movable piece may coincide with the first direction or may be close to the first direction.

The fulcrum (that is, the first end of the first arm) may remain stationary or may slightly move during a time period from when the first operating portion is manually moved until a load begins to be applied to the first movable piece.

One embodiment may include at least any one of the following features in addition to or in place of at least any one of Features 1 through 23 mentioned above.
Feature 24: the first arm includes a first initial portion.
Feature 25: the first initial portion corresponds to a portion of the first arm that extends from the first end in a first extension-starting direction (that is, a portion including the first end). The first extension-starting direction is perpendicular to the first direction.
Feature 26: the first arm includes a first continuing portion.
Feature 27: the first continuing portion corresponds to a portion of the first arm that extends from an edge of the first initial portion (that is, an end portion opposite to the first end) in a first extension-continuing direction. The first extension-continuing direction is perpendicular to the first direction. The first continuing portion may include the second end of the first arm.
Feature 28: the first extension-continuing direction is different from the first extension-starting direction.

In the job-site electric device that includes at least Features 1 through 20, and 24 through 28, the length of the first arm can be increased, and it is accordingly possible to reduce the force necessary to move the first movable piece. In addition, it is also possible to efficiently use the space around the first arm compared to a case where the entirety of the first arm is linearly formed.

When the first arm is viewed from outside of the first arm in a direction perpendicular to the reference plane, the first extension-starting direction can also be described as a direction in which the first arm extends from the first end. The direction perpendicular to the reference plane is perpendicular to the first reference plane. Alternatively, the first extension-starting direction can also be described as a component of a direction (or a vector component) parallel to the first reference plane in the direction in which the first arm extends from the first end (or a vector in this direction).

When the first arm is viewed from outside of the first arm in the direction perpendicular to the reference plane, the first extension-continuing direction can also be described as a direction in which the first continuing portion extends from an edge of the first initial portion. Alternatively, the first extension-continuing direction can also be described as a component of a direction (or a vector component) parallel to the first reference plane in a direction in which the first continuing portion extends from the edge of the first initial portion (or a vector in this direction).

One embodiment may include at least any one of the following features in addition to or in place of at least any one of Features 1 through 28 mentioned above.
Feature 29: the first arm includes a width and a thickness. The width is at least twice the thickness.
Feature 30: the width is a length measured in a direction that is perpendicular to the direction in which the first arm extends and that is parallel to the first reference plane.
Feature 31: The thickness is a length measured in a direction that is perpendicular to the direction in which the first arm extends and that is perpendicular to the width.

In the job-site electric device that includes at least Features 1 through 20, and 29 through 31, it is inhibited or prevented that the first arm is twisted when the first operating portion is manually moved by the user. Being twisted may include being displaced in a direction of a rotation about a direction of extension of the first operating portion.

One embodiment may include at least any one of the following features in addition to or in place of at least any one of Features 1 through 31 mentioned above.
Feature 32: the support body includes a first opening.
Feature 33: the first opening is open (or extending) in the first direction.
Feature 34: the first manually operating member is situated in the first opening.
Feature 35: a light emitter.
Feature 36: the light emitter is situated away from the first opening in the first direction.
Feature 37: the light emitter is configured to emit light through the first opening.

In the job-site electric device that includes at least Features 1 through 20 and 32 through 37, it is possible to reduce the space necessary to arrange the first switch and the light emitter.

The first manually operating member may partially close the first opening. The light emitter may be configured to emit light at least in the second direction. A portion of or all of the light emitted in the second direction may be emitted outside the job-site electric device through the first opening. The light emitter may have any shape that allows emission of light. The light emitter may be used for lighting. The light emitter may be used for providing information. Examples of the light emitter include an LED.

One embodiment may include at least any one of the following features in addition to or in place of at least any one of Features 1 through 37 mentioned above.
Feature 38: the support body includes a first auxiliary arm (or an auxiliary arm).
Feature 39: the first auxiliary arm extends from the first end of the first arm in a direction approaching the first reference plane (that is, the second direction, or a direction that includes a component of the second direction).
Feature 40: the first auxiliary arm includes a first auxiliary end that is coupled to the first end of the first arm.
Feature 41: the first auxiliary arm includes a second auxiliary end. The second auxiliary end may be an end portion opposite to the first auxiliary end.

In the job-site electric device that includes at least Features 1 through 20 and 38 through 41, it is possible to facilitate displacement of the first arm about its first end as the fulcrum.

The first operating portion, the first arm, and the first auxiliary arm may be integrally molded (in other words, may be in a form of a single member). In other words, the integrally molded member, which will be mentioned below, may include at least two of the first operating portion, the first arm, or the first auxiliary arm. The second auxiliary end may be coupled to a given part of the support body.

One embodiment may include the following feature in addition to or in place of at least any one of Features 1 through 41 mentioned above.
Feature 42: a first planar distance of the first arm is longer than a second planar distance of the first auxiliary arm. The first planar distance is a distance from the first end to the second end of the first arm in a direction parallel to the first reference plane (that is, a direction along the first reference plane). The second planar distance is a distance from the first auxiliary end to the second auxiliary end of the first auxiliary arm in a direction parallel to the first reference plane.

In the job-site electric device that includes at least Features 1 through 20 and 38 through 42, a vector of the force applied from the first operating portion to the switch surface can be made to coincide with or closer to the first direction.

One embodiment may include the following feature in addition to or in place of at least any one of Features 1 through 42 mentioned above.
Feature 43: a first angle of the first arm is less than a second angle of the first auxiliary arm. The first angle is an angle formed between the first reference plane and a main extension direction. The main extension direction is a direction from the first end of the first arm to the second end of the first arm. The second angle is an angle formed between the first reference plane and an auxiliary extension direction. The auxiliary extension direction is a direction from the first auxiliary end of the first auxiliary arm to the second auxiliary end of the first auxiliary arm. The first angle and the second angle are less than 90°.

In the job-site electric device that includes at least Features 1 through 20, 38 through 41, and 43, a vector of the force applied from the first operating portion to the switch surface can be made to coincide with or closer to the first direction.

One embodiment may include at least any one of the following features in addition to or in place of at least any one of Features 1 through 43 mentioned above.
Feature 44: an integrally molded member including the first arm and the first auxiliary arm. The integrally molded member may be in a form of a single member.
Feature 45: the integrally molded member includes a bent portion.
Feature 46: the bent portion corresponds to a border between the first arm and the first auxiliary arm.
Feature 47: the bent portion corresponds to a portion of the integrally molded member that is bent. The bent portion may be bent in the first direction and/or the second direction.
Feature 48: the bent portion is configured to be elastically deformed in response to the first operating portion being manually moved in the first direction and thereby cause the first operating portion to be displaced in the first direction.

Feature 44 may also be described as the first arm and the first auxiliary arm being integrally molded and/or the first arm, the first auxiliary arm, and the bent portion being integrally molded. Each of the first arm and the first auxiliary arm may extend from the bent portion so as to approach the first reference plane.

In the job-site electric device that includes at least Features 1 through 20, 38 through 41, and 44 through 48, it is possible to facilitate displacement of the first arm about its first end as the fulcrum, and/or it is possible to easily achieve such a configuration.

The integrally molded member may also include the first operating portion. The elastic deformation of the bent portion may also be described as an increase in an angle between the first arm and the first auxiliary arm.

One embodiment may include at least any one of the following features in addition to or in place of at least any one of Features 1 through 48 mentioned above.
Feature 49: the support body includes a support member.
Feature 50: the second auxiliary end is integrally coupled to the support member and thereby the support member supports the first manually operating member via the first auxiliary arm. The support member may be included in the integrally molded member.
Feature 51: the first auxiliary arm is configured to be elastically deformable about the second auxiliary end as the fulcrum.
Feature 52: a first spring constant is greater than a second spring constant.
Feature 53: the first spring constant is a spring constant of the second auxiliary end of the first auxiliary arm. The first spring constant shows difficulty in elastic deformation of the root of the first auxiliary arm (that is, the second auxiliary end) relative to the support member. The elastic deformation of the second auxiliary end may be caused by a force applied from the first operating portion to the first auxiliary arm via the first arm. This force may be applied to the first auxiliary arm in response to the first operating portion being manually moved in the first direction.
Feature 54: the second spring constant shows difficulty in elastic deformation of the bent portion. The elastic deformation of the bent portion may be caused by a force applied from the first operating portion to the first arm. This force may be applied to the first arm in response to the first operating portion being manually moved in the first direction.

In the job-site electric device that includes at least Features 1 through 20, 38 through 41, and 44 through 54, the elastic deformation of the second auxiliary end, which is caused in response to the first operating portion being manually moved, can be reduced compared to the elastic deformation of the bent portion. Alternatively, it is possible to prevent the elastic deformation of the second auxiliary end. This facilitates displacement of the first arm about the bent portion as the fulcrum.

The support member may have a plate-like shape. The first opening may be disposed in the support member. The entirety of the support body may be integrally molded.

One embodiment may include at least any one of the following features in addition to or in place of at least any one of Features 1 through 54 mentioned above.
Feature 55: a second switch.
Feature 56: the second switch includes a second movable piece (or a second movable portion, or a second push rod, or a second actuator).
Feature 57: the second movable piece is configured to move in the first direction in response to receiving a second load in the first direction.
Feature 58: a second manually operating member. The second manually operating member may be configured to be manually moved (for example, pressed in the first direction) by the user.
Feature 59: the second manually operating member includes a second operating portion (or a second button).
Feature 60: the second operating portion is situated away from the second movable piece in the second direction. The second operating portion may be configured to be manually moved (for example, pressed in the first direction) by the user.
Feature 61: the second operating portion is configured to be displaced in the first direction in response to being manually moved in the first direction.
Feature 62: the second operating portion is configured to be displaced in the first direction in response to being manually moved in the first direction and thereby apply the second load to the second movable piece. The second operating portion may be configured to come in contact with the second movable piece directly or indirectly and thereby apply the second load to the second movable piece.
Feature 63: the second manually operating member includes a second arm.
Feature 64: the second arm includes a first end.
Feature 65: the second arm includes a second end.
Feature 66: the second end of the second arm is coupled to the second operating portion.
Feature 67: in a second initial state, the first end of the second arm is situated away from a second reference plane in the first direction.
Feature 68: the second initial state is a state in which the second manually operating member is not manually moved.
Feature 69: the second reference plane is perpendicular to the first direction.
Feature 70: the second reference plane is an imaginary plane that passes through the second end of the second arm.

The first end of the second arm may be coupled to the support body. The first end of the second arm may be coupled to a different support body different from the support body. The support body or the different support body may include a second auxiliary arm. The second auxiliary arm may include a configuration that is identical or similar to the configuration of the first auxiliary arm. The first end of the second arm may be coupled to the first end of the second auxiliary arm. The second end of the second auxiliary arm may be coupled to the support member of the support body or to a support member of the different support body. The second arm and the second auxiliary arm may include features among Features 1 through 54 that are identical or corresponding to the features of the first arm and the first auxiliary arm.

In the job-site electric device that includes at least Features 1 through 20, and 55 through 70, the first end of the second arm is situated further in the first direction than the second end of the second arm is. Thus, it is possible to reduce the force necessary for the user to operate the second switch.

The second reference plane may be parallel to the first reference plane. The second reference plane may coincide with the first reference plane.

The second operating portion may be configured to be manually and directly moved by the user.

The second operating portion may be configured to be manually and indirectly moved by the user. Specifically, a second given member (for example, a cover or a film) may be disposed adjacent to the second operating portion on its second direction side. The second given member may be manually moved by the user, and thereby the second operating portion may be moved by the second given member. In other words, the second operating portion may be manually and indirectly moved by the user via the second given member.

The second switch may include a second electric contact. The second electric contact may be configured to be closed or opened in response to the second movable piece being moved in the first direction (or moved for a fixed length or more). The second switch may be configured for so-called momentary operation or may be configured for so-called alternate operation.

In the second initial state, the second movable piece may be situated at a second initial position. The second movable piece may be configured to move in the first direction (or move for a fixed length or more) from the second initial position in response to receiving the second load.

The second arm may extend from the second operating portion in any manner. The second arm may have a long and thin plate-like (or a rod-like) shape. A second distance, which is from the second reference plane to the second arm, may vary depending on the position of the second arm, for example. The second distance may increase continuously or intermittently from the second end to the first end of the second arm. There may be a part between the second end to the first end of the second arm where the second distance decreases.

The first end of the second arm may be defined as a boundary from the support body when the second arm is coupled to the support body. Alternatively, the first end of the second arm may be defined as a given area or a given position within the boundary. Specifically, the first end of the second arm may be defined as a whole of a connecting surface (that is, a cross section) coupled to the support body or as a given area or a given position within the connecting surface (for example, an end or an intermediate position of the connecting surface in the first direction).

The second end of the second arm may be defined as a boundary from the second operating portion or as a given area or a given position within the boundary. Specifically, the second end of the second arm may be defined as a whole of a connecting surface (that is, a cross section) coupled to the second operating portion or as a given area or a given position within the connecting surface (for example, an end or an intermediate position of the connecting surface in the first direction).

The second operating portion, the second arm, and the support body may be integrally molded. The integrally molded member may further include the second operating portion and/or the second arm.

The second switch may be configured in the same manner as the first switch. In other words, the second switch may have the same shape and the same size as the first switch.

The second arm may be configured in the same manner as the first arm. In other words, the second arm may have the same shape and the same size as the first arm. The second switch may include features among Features 1 through 54 that are identical or corresponding to the features of the first switch.

The second manually operating member may include features among Features 1 through 54 that are identical or corresponding to the features of the first manually operating member.

One embodiment may include at least any one of the following features in addition to or in place of at least any one of Features 1 through 70 mentioned above.
Feature 71: the first arm extends from the first end of the first arm in a direction away from the first end of the second arm.
Feature 72: the second arm extends from the first end of the second arm in a direction away from the first end of the first arm.

In the job-site electric device that includes at least Features 1 through 20, and 55 through 72, the first switch and the second switch can be easily situated away from each other.

One embodiment may include at least any one of the following features in addition to or in place of at least any one of Features 1 through 72 mentioned above.
Feature 73: an angle formed between the first extension-starting direction of the first arm and a second extension-starting direction of the second arm is greater than 170° and less than or equal to 180°. This angle may be 180°.
Feature 74: the first extension-starting direction is a direction in which the first arm extends from the first end of the first arm and that is perpendicular to the first direction.
Feature 75: the second extension-starting direction is a direction in which the second arm extends from the first end of the second arm and that is perpendicular to the first direction.

In the job-site electric device that includes at least Features 1 through 20, and 55 through 75, the first switch and the second switch can be easily situated away from each other.

When the second arm is viewed from outside of the second arm in the direction perpendicular to the reference plane (or in a direction perpendicular to the second reference plane), the second extension-starting direction can also be described as a direction in which the second arm extends from the first end. Alternatively, the second extension-starting direction can also be described as a component of a direction (or a vector component) parallel to the first reference plane (or the second reference plane) in a direction in which the second arm extends from the first end of the second arm (or a vector of this direction).

One embodiment may include at least any one of the following features in addition to or in place of at least any one of Features 1 through 75 mentioned above.
Feature 76: the second arm includes a second initial portion.
Feature 77: the second initial portion corresponds to a part of the second arm that extends from the first end of the second arm in the second extension-starting direction (that is, a part of the second arm that includes the first end of the second arm).
Feature 78: the second arm includes a second continuing portion.
Feature 79: the second continuing portion corresponds to a part of the second arm that extends from an edge of the second initial portion (that is, an edge opposite to the first end of the second arm) in a second extension-continuing direction. The second continuing portion may include the second end of the second arm. The second extension-continuing direction is perpendicular to the first direction.
Feature 80: the second extension-continuing direction is different from the second extension-starting direction.
Feature 81: both of the first continuing portion and the second continuing portion extend toward an imaginary straight line that passes through the second end of the first arm and the second end of the second arm.

In the job-site electric device that includes at least Features 1 through 20, 24 through 28, and 55 through 81, the first switch and the second switch are easily situated away from each other, and it is possible to increase efficiency in using a space around the first switch and the second switch.

When the second arm is viewed from outside of the second arm in the direction perpendicular to the reference direction (or in a direction perpendicular to the second reference plane), the second extension-continuing direction may also be described as a direction in which the second continuing portion extends from the edge of the second initial portion. Alternatively, the second extension-continuing direction may also be described as a component of a direction (or a vector component) parallel to the first reference plane (or the second reference plane) in a direction in which the second continuing portion extends from the edge of the second initial portion (or a vector of this direction).

One embodiment may include at least any one of the following features in addition to or in place of at least any one of Features 1 through 81 mentioned above.
Feature 82: a third switch.
Feature 83: the third switch includes a third movable piece (or a third movable portion, or a third push rod, or a third actuator).
Feature 84: the third movable piece is configured to move in the first direction in response to receiving a third load in the first direction.
Feature 85: a third manually operating member. The third manually operating member may be configured to be manually moved (for example, pressed in the first direction) by the user.
Feature 86: the third manually operating member includes a third operating portion (or a third button).
Feature 87: the third operating portion is situated away from the third movable piece in the second direction. The third operating portion may be configured to be manually moved (for example, pressed in the first direction) by the user.
Feature 88: the third operating portion is configured to be displaced in the first direction in response to being manually moved in the first direction.
Feature 89: the third operating portion is configured to be displaced in the first direction in response to being manually moved in the first direction and thereby configured to apply the third load to the third movable piece. The third operating portion may be configured to come in contact with the third movable piece directly or indirectly and thereby configured to apply the third load to the third movable piece.
Feature 90: the third manually operating member includes a third arm.
Feature 91: the third arm includes a first end.
Feature 92: the third arm includes a second end.
Feature 93: the second end of the third arm is coupled to the third operating portion.
Feature 94: in a third initial state, the first end of the third arm is situated away from a third reference plane in the first direction.
Feature 95: the third initial state is a state in which the third manually operating member is not manually moved.
Feature 96: the third reference plane is perpendicular to the first direction.
Feature 97: the third reference plane is an imaginary plane that passes through the second end of the third arm.
Feature 98: the first operating portion, the second operating portion, and the third operating portion are not aligned on a same straight line (that is, not collinear).

The first end of the third arm may be coupled to the support body. The first end of the third arm may be coupled to a different support body to which the first arm and the second arm are not coupled. The support body or the different support body may include a third auxiliary arm. The third auxiliary arm may be configured identically or similarly to the first auxiliary arm. The first end of the third arm may be coupled to a first end of the third auxiliary arm. The second end of the third auxiliary arm may be coupled to the support member of the support body or to the support member of the different support body. The third arm and the third auxiliary arm may include features among Features 1 through 54 that are identical or corresponding to the features of the first arm and the first auxiliary arm.

In the job-site electric device that includes at least features 1 through 20, 55 through 70, and 82 through 98, the first end of the third arm is situated further in the first direction than the second end of the third arm is. Thus, it is possible to reduce the force necessary for the user to operate the third switch.

The third reference plane may be parallel to the first reference plane and/or the second reference plane. The third reference plane may coincide with the first reference plane and/or the second reference plane.

The third operating portion may be configured to be manually and directly moved by the user.

The third operating portion may be configured to be manually and indirectly moved by the user. Specifically, a third given member (for example, a cover or a film) may be disposed adjacent to the third operating portion on its second direction side. The third given member may be manually moved by the user, and thereby the third operating portion may be moved by the third given member. In other words, the third operating portion may be manually and indirectly moved by the user via the third given member.

The third switch may include a third electric contact. The third electric contact may be configured to be closed or opened in response to the third movable piece being moved (or moved for a fixed length or more) in the first direction. The third switch may be configured for so-called momentary operation or may be configured for so-called alternate operation.

In the third initial state, the third movable piece may be situated at a third initial position. The third movable piece may be configured to move (or move for a fixed length or more) in the first direction from the third initial position in response to receiving the third load.

The third arm may extend from the third operating portion in any manner. The third arm may have a long and thin plate-like (or a rod-like) shape. A third distance, which is from the third reference plane to the third arm, may vary depending on the position of the third arm. The third distance may increase continuously or intermittently from the second end of the third arm to the first end of the third arm, for example. There may be an area between the second end to the first end of the third arm where the third distance decreases.

The first end of the third arm may be defined as a boundary from the support body when the third arm is coupled to the support body. Alternatively, the first end of the second arm may be defined as a given area or a given position within the boundary. Specifically, the first end of the third arm may be defined as a whole of a connecting surface (that is, a cross section) coupled to the support body or as a given area or a given position within the connecting surface (for example, an end or an intermediate position of the connecting surface in the first direction).

The second end of the third arm may be defined as a boundary from the third operating portion or as a given area or a given position within the boundary. Specifically, the second end of the third arm may be defined as a whole of a connecting surface (that is, a cross section) coupled to the third operating portion or as a given area or a given position within the connecting surface (for example, an end or an intermediate position of the connecting surface in the first direction).

The third operating portion, the third arm, and the support body maybe integrally molded. The integrally molded member may further include the third operating portion and/or the third arm.

The third switch may be configured in the same manner as the first switch or the second switch. In other words, the third switch may have the same shape and the same size as the first switch and/or the second switch.

The third arm may be configured in the same manner as the first arm and/or the second arm. In other words, the third arm may have the same shape and the same size as the first arm and/or the second arm.

The third switch may include features among Features 1 through 54 that are identical or corresponding to the features of the first switch.

The third manually operating member may include features among Features 1through 54 that are identical or corresponding to the features of the first manually operating member.

One embodiment may include the following feature in addition to or in place of at least any one of Features 1 through 98 mentioned above.
Feature 99: an angle formed between a first separation direction and a second separation direction is greater than 80° and less than or equal to 100°. This angle may be 90°. The first separation direction is a direction from the second operating portion to the first operating portion and is perpendicular to the first direction. The second separation direction is a direction from the second operating portion to the third operating portion and is perpendicular to the first direction.

In the job-site electric device that includes at least Features 1 through 20, 55 through 70, and 82 through 99, it is possible to reduce an area necessary to arrange the first switch, the second switch, and the third switch.

The first separation direction may also be described as a component of a direction (or a vector component) parallel to the first reference plane (or the second reference plane, or the third reference plane) in a direction from the second operating portion to the first operating portion (or a vector of this direction). “The direction from the second operating portion to the first operating portion” may also be, for example, a direction from a given position within a surface and an entire inner body of the second operating portion to a given position within a surface and an entire inner body of the first operating portion.

The second separation direction may also be described as a component of a direction (or a vector component) parallel to the first reference plane (or the second reference plane, or the third reference plane) in a direction from the second operating portion to the third operating portion (or a vector of this direction). “The direction from the second operating portion to the third operating portion” may also be, for example, a direction from a given position within a surface and an entire inner body of the second operating portion to a given position within a surface and an entire inner body of the third operating portion.

One embodiment may include at least any one of the following features in addition to or in place of at least any one of Features 1 through 99 mentioned above.
Feature 100: a display.
Feature 101: the display is situated away from the second switch in a third separation direction. The third separation direction is a direction resultant from a combination of (i.e., obtained by vector addition of) the first separation direction and the second separation direction.
Feature 102: the display is configured to display information related to operation of the job-site electric device.

In the job-site electric device that includes at least Features 1 through 20, 55 through 70, and 82 through 102, it is possible to effectively arrange the first to the third switches and the display (for example, while reducing the area for installment).

The display may include at least one LED and/or a display device of various kind, for example. The display may include a seven-segment LED, for example. The display may include a display of various kind such as a liquid crystal display or an organic electroluminescence display. The display may include a simple lighting device (or a light emitter).

Now, an imaginary parallelogram that passes through the first to the third switches is defined as follows. The parallelogram includes a first vertex, a second vertex, a third vertex, and a fourth vertex. The first vertex is situated within the first switch. The second vertex is situated within the second switch. The third vertex is situated within the third switch. In this situation, the display may be disposed such that the fourth vertex is situated within the display. The parallelogram may be situated parallel to the first reference plane, the second reference plane, and/or the third reference plane.

One embodiment may include at least any one of the following features in addition to or in place of at least any one of Features 1 through 102 mentioned above.
Feature 103: at least two of the first extension-starting direction of the first arm, the second extension-starting direction of the second arm, or a third extension-starting direction of the third arm are different from each other.
Feature 104: the third extension-starting direction is a direction in which the third arm extends from the first end of the third arm and that is perpendicular to the first direction.

In the job-site electric device that includes at least Features 1 through 20, 25, 55 through 70, 75, 82 through 98, and 103 through 104, it is possible to effectively arrange the first to the third switches (for example, while reducing the area for installment of these switches).

When the third arm is viewed from outside of the third arm in the direction perpendicular to the reference plane (or in a direction perpendicular to the second reference plane or the third reference plane), the third extension-starting direction can also be described as a direction in which the third arm extends from the first end. Alternatively, the third extension-starting direction can also be described as a component of a direction (or a vector component) parallel to the first reference plane (or the second reference plane or the third reference plane) in a direction in which the third arm extends from the first end of the third arm (or a vector of this direction).

One embodiment may include the following feature in addition to or in place of at least any one of Features 1 through 104 mentioned above.
Feature 105: The first extension-starting direction, the second extension-starting direction, and the third extension-starting direction are different from one another.

In the job-site electric device that includes at least Features 1 through 20, 25, 55 through 70, 75, 82 through 98, and 103 through 105, it is possible to effectively arrange the first to the third switches (for example, while reducing the area for installment of these switches) and to achieve various kinds of arrangement of these switches.

One embodiment may include the following feature in addition to or in place of at least any one of Features 1 through 105 mentioned above.
Feature 106: an angle formed between the second extension-starting direction and the third extension-starting direction is greater than 170° and less than or equal to 180°. This angle may be 180°.

One embodiment may include the following feature in addition to or in place of at least any one of Features 1 through 106 mentioned above.
Feature 107: the first extension-starting direction is nonparallel to the second extension-starting direction and the third extension-starting direction. The second extension-starting direction may be parallel to or nonparallel to the third extension-starting direction.

One embodiment may include at least any one of the following features in addition to or in place of at least any one of Features 1 through 107 mentioned above.
Feature 108: a housing.
Feature 109: the housing houses the first switch, the second switch, and/or the third switch.
Feature 110: the housing includes the first housing.
Feature 111: the housing includes a second housing.
Feature 112: the first housing and the second housing may be combined with each other to thereby assemble the housing.
Feature 113: the support body has a plate-like shape and includes an outer circumference.
Feature 114: the first housing includes a first support portion.
Feature 115: a first outer circumferential portion of the support body is fitted into the first support portion, and thereby the first support portion supports the support body. The first outer circumferential portion is a first portion of the outer circumference.
Feature 116: the second housing supports a second support portion.
Feature 117: a second outer circumferential portion of the support body is fitted into the second support portion, and thereby the second support portion supports the support body. The second outer circumferential portion is a second portion of the outer circumference and is different from the first outer circumferential portion.
Feature 118: a shape of the second outer circumferential portion is different from a shape of the first outer circumferential portion.

In the job-site electric device that includes at least Features 1 through 20, and 108 through 118, the support body can be properly assembled (for example, fitted) to the first housing or to the second housing during the process of manufacturing the job-site electric device.

Now, it is assumed that the shape of the second outer circumferential portion is the same as the shape of the first outer circumferential portion. In this case, the user may erroneously have (or try to have) the second outer circumferential portion fitted into the first support portion of the first housing. Considering the workability, it is desirable that the support body can be properly and easily fitted into the first support portion.

Whereas, if the job-site electric device includes Feature 118, it is possible to inhibit or prevent such an erroneous fitting as mentioned above from happening.

The support body may include a flange (or a rib) that is formed along the outer circumference of the support body. The flange may be formed along the entirety of the outer circumference of the support body or may be formed partially along the outer circumference. The first outer circumferential portion and/or the second outer circumferential portion may be disposed in the flange.

Feature 118 may also be described as follows: the first outer circumferential portion and the second outer circumferential portion are asymmetric to each other.

The first switch, the second switch and/or the third switch may be directly or indirectly fixed to the support body.

One embodiment may include the following feature in addition to or in place of at least any one of Features 1 through 118 mentioned above.
Feature 119: in the unassembled state, the support body is configured to be fitted into the first support portion in a given fitting direction. The unassembled state is a state in which the support body is not assembled to the housing, and in which the second housing is situated away from the first housing.

In the job-site electric device that includes at least Features 1 through 20, and 108 through 119, it is possible to have the support body fitted into the first housing easily and properly during the process of manufacturing the job-site electric device. One embodiment may include at least any one of the following features in addition to or in place of at least any one of Features 1 through 119 mentioned above.
Feature 120: the outer circumference of the support body includes a first linear area.
Feature 121: the first linear area is a linear area that includes one of two borders between the first outer circumferential portion and the second outer circumferential portion of the outer circumference.
Feature 122: the outer circumference of the support body includes a second linear area.
Feature 123: the second linear area is a linear area that includes another one of the two borders.

In the job-site electric device that includes at least Features 1 through 20 and 108 through 123, it is possible to stably fix the support body to the first support portion (in other words, make it difficult to remove the support body from the first support portion) in a semifixed state. The semifixed state is a state in which the support body has been fitted to the first housing while the second housing has not been assembled to the first housing in the process of manufacturing the job-site electric device. In other words, in the semifixed state, the second outer circumferential portion of the support body has not been fitted into the second housing yet.

If the first linear area and/or the second linear area do not exist, or, the first linear area and/or the second linear area are small, the support body may easily come off from the first housing in the semifixed state. However, it is desirable that the support body does not easily come off from the first housing in the semifixed state. Meanwhile, it is possible to make it difficult to have the support body come off from the first housing by including the first linear area and the second linear area.

One embodiment may include the following feature in addition to or in place of at least any one of Features 1 through 123 mentioned above.
Feature 124: the first linear area and the second linear area are parallel to the fitting direction.

In the job-site electric device that includes at least Features 1 through 20, and 108 through 124, it is possible to easily have the support body fitted into the first housing in the process of manufacturing the job-site electric device and it is also possible to make it difficult to have the support body come off from the first support portion after being fitted into the first housing.

One embodiment may include at least any one of the following features in addition to or in place of at least any one of Features 1 through 124 mentioned above.
Feature 125: the first outer circumferential portion includes a first curved area that is curved.
Feature 126: the first outer circumferential portion includes a second curved area that is curved.
Feature 127: the second outer circumferential portion includes a third curved area that is curved.
Feature 128: the second outer circumferential portion includes a fourth curved area that is curved.
Feature 129: curvature of the first curved area is greater than curvature of the third curved area and curvature of the fourth curved area.
Feature 130: curvature of the second curved area is greater than the curvature of the third curved area and the curvature of the fourth curved area.

In the job-site electric device that includes at least Features 1 through 20, 108 through 119, and 125 through 130, it is possible to easily assemble the second housing to the support body in the semifixed state.

As the curvature of the third curved area and the curvature of the fourth curved area increase (in other words, as a radius of curvature of the third curved area and a radius of curvature of the fourth curved area decrease), it can become difficult to have the second outer circumferential portion fitted into the second support portion of the second housing. In other words, workability of the work of assembling the second housing to the first housing from the semifixed state may decrease.

Whereas, it becomes easier to have the second outer circumferential portion fitted into the second support portion of the second housing by decreasing the curvature of the third curved area and the curvature of the fourth curved area (in other words, by increasing their radiuses of curvature).

Meanwhile, it is possible to make it difficult to have the support body come off from the first housing in the semifixed state by relatively increasing the curvature of the first curved area and the curvature of the second curved area.

One embodiment may include at least any one of the following features in addition to or in place of at least any one of Features 1 through 130 mentioned above.
Feature 131: an electric load.
Feature 132: a control circuit.
Feature 133: the control circuit is configured to control the electric load.
Feature 134: a circuit board.
Feature 135: the control circuit is mounted (or installed) on the circuit board.
Feature 136: the first switch, the second switch, and/or the third switch are fixed to (or installed on) the circuit board.
Feature 137: the support body is fixed to the circuit board.

In the job-site electric device that includes at least Features 1 through 20, and 131 through 137, it is possible to compactly keep the circuit board and the first to the third switches inside the job-site electric device.

Aforementioned Features 120, 122, 129, and/or 130 are more effective when the job-site electric device includes Feature 137. In other words, when the support body that is fixed to the circuit board is fitted into the first support portion, the support body may easily come off from the first housing due to the weight of the circuit board. In this case, if the job-site electric device includes aforementioned Features 120, 122, 129, and/or 130, it can be made less likely that the support body comes off from the first housing.

The housing may include an opening. The first support portion and the second support portion may be disposed along the opening (in other words, so as to surround the opening). The opening may include a first opening portion where the first support portion is situated and a second opening portion where the second support portion is situated. The support body may be disposed so as to cover (close) the opening.

The electric load may include a motor. Examples of the motor include a DC brushed motor, a brushless motor (including a DC brushless motor and/or an AC brushless motor), an AC motor, and a stepper motor. The electric load may include a load other than a motor. Examples of the electric load include a heater and a light emitting device that emits light.

The first switch, the second switch, and/or the third switch may be electrically coupled to the control circuit or may be coupled to a circuit different from the control circuit.

The control circuit may be configured to set, change, or switch actuation/non-actuation of the electric load, operating methods, controlling methods, operation modes, various kinds of parameters associated with the operation of the electric load, actuation/non-actuation of the control circuit per se, and the like depending on the state (opened state or closed state) of the first switch, the second switch, and/or the third switch.

The control circuit may be integrated into a single electronic unit, a single electronic device, or a single circuit board.

The control circuit may be a combination of at least two electronic circuits, at least two electronic units, or at least two electronic devices separately disposed on or in the job-site electric device.

The control circuit may include a microcomputer (or a microcontroller, or a microprocessor), a wired logic connection, an application specific integrated circuit (ASIC), an application specific standard product (ASSP), a programmable logic device (such as a field programmable gate array (FPGA)), a discrete electronic component, and/or a combination thereof.

The job-site electric device may include all devices that are configured to operate in response to receiving direct-current power or alternating-current power. The job-site electric device may be configured to receive the alternating-current power, or to receive the direct-current power. The job-site electric device may include a battery installed therein and may be configured to operate by using electric power of the battery. The job-site electric device may be configured to allow a battery pack containing the battery to be detachably attached thereto. The job-site electric device may be configured to operate in response to receiving the electric power of the battery from the battery pack. The battery may be repeatedly chargeable.

The job-site electric device may include a power transmitter. The power transmitter is configured to transmit rotations of the motor to a driven tool. The driven tool may be fixed to the job-site electric device or configured to be detachably attached to the job-site electric device. Examples of the driven tool include various kinds of bits, a rotary blade or a cutting blade, a saw chain, and a fan or an impeller of a pump.

The job-site electric device may include a grip. The grip may be configured to be held by the user. The job-site electric device may include a trigger. The trigger may be configured to be manually operated by the user. The job-site electric device may be configured such that the user can manually operate the trigger while holding the grip.

Examples of the job-site electric device include electric apparatuses of various kinds used (or that may be used) in a work site of building construction, other construction, manufacturing, civil engineering, agriculture, gardening, cleaning, home carpentry, or the like. Specific examples of the job-site electric device include an electric power tool or an electric work machine for stone processing, metal processing, or wood processing, an electric work machine for gardening, and an apparatus for improving environment of the work site. More specific examples of the job-site electric device include an electric blower, an electric hammer, an electric hammer drill, an electric drill, an electric screwdriver, an electric wrench, an electric grinder, an electric circular saw, an electric reciprocating saw, an electric jigsaw, an electric cutter, an electric chainsaw, an electric planer, an electric nailer (including a tacker), an electric hedge trimmer, an electric lawn mower, an electric lawn trimmer, an electric grass cutter, an electric cleaner, an electric sprayer, an electric spreader, an electric dust collector, an electric trowel, an electric vibrator, an electric rammer, an electric compactor, an electric pump, an electric pile driver, an electric concrete saw, an electric screed, an electric cut-off saw, a laser range meter (or a laser distance measurer), a laser marker, a beam receiver of a laser marker, a wall scanner, a radio, a television, a speaker, a light (that is, a lighting device), an electric cooler/warmer, an electric kettle, a coffee machine (or a coffee maker, or a coffee distiller), a microwave oven, a robot vacuum cleaner, a battery-operated wheel barrow, a battery-operated bicycle, a fan vest, and a heated jacket.

In one embodiment, aforementioned Features 1 through 137 may be combined in any combinations.

In one embodiment, any one of aforementioned Features 1 through 137 may be omitted.

### 2. Specific Example Embodiments

Hereinafter, specific example embodiments will be explained.

### 2-1. First Embodiment

The first embodiment provides a job-site electric device 1 in a form of a drill driver. The job-site electric device 1 is used in a work of screw fastening and drilling of a hole, for example. However, such a job-site electric device 1 is merely an example, and the present disclosure can be applied to any form of the job-site electric device.

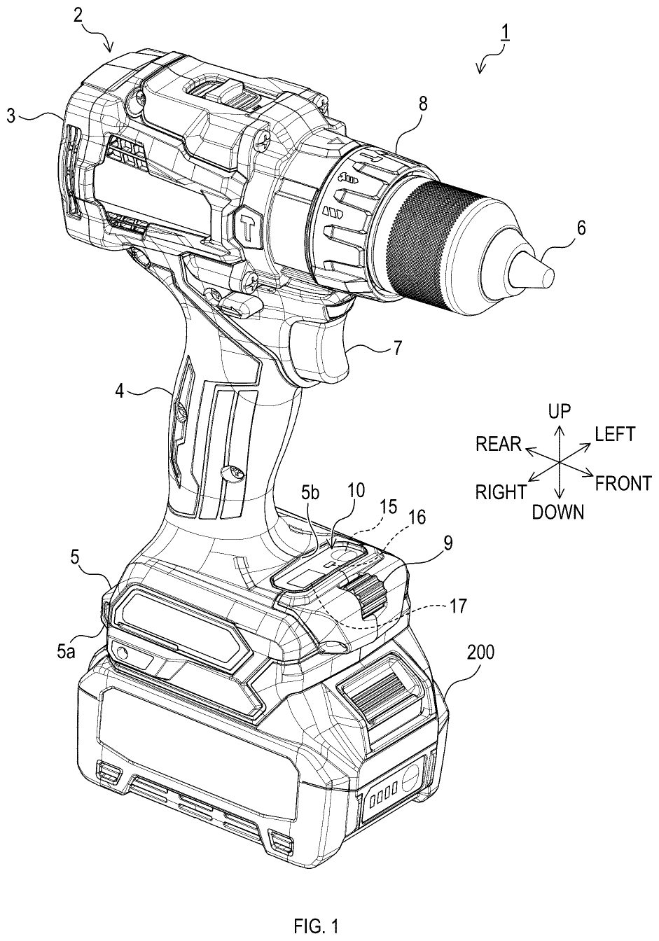

For convenience of explanation, in the first embodiment, directions with respect to the job-site electric device 1 will be defined as appropriately shown in FIG. 1 and the subsequent drawings. Specifically, “up” (upward direction), “down” (downward direction), “right” (right direction), “left” (left direction), “front” (front direction), and “rear” (rear direction) will be defined. The same applies to the second to the fourth embodiments which will be mentioned below. The downward direction is an example of the first direction mentioned in the Overview of Embodiments. The upward direction is an example of the second direction mentioned in the Overview of Embodiments.

### (2-1-1) Overall Configuration of Job-Site Electric Device

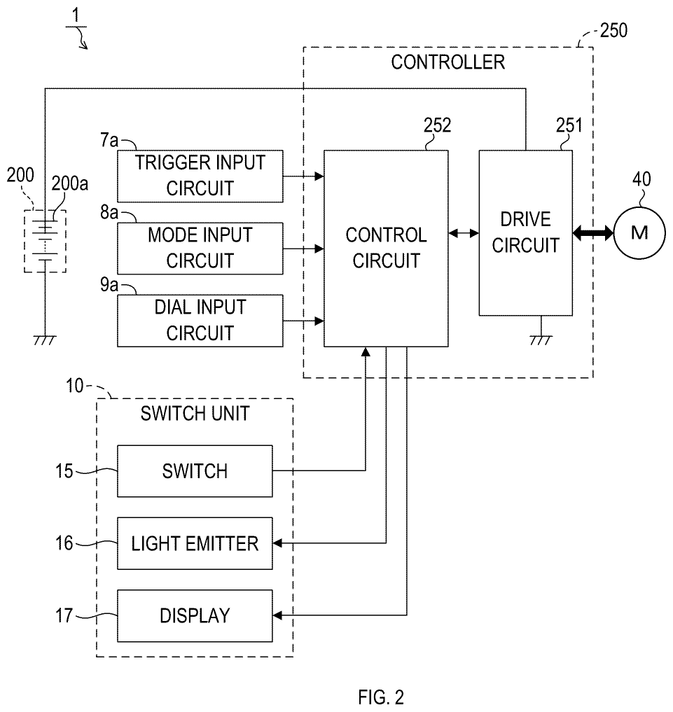

As shown in FIG. 1, the job-site electric device 1 includes a housing 2. The housing 2 includes a first storage 3. The first storage 3 stores a motor 40 (not illustrated, see FIG. 2).

The housing 2 includes a grip 4. The grip 4 is held by a user of the job-site electric device 1.

The job-site electric device 1 includes a trigger 7. The trigger 7 is situated in a front portion of the grip 4 near a border between the grip 4 and the first storage 3. The trigger 7 is manually operated by the user to rotate the motor 40.

The housing 2 includes a second storage 5. The second storage 5 includes a battery port 5a in its lower end portion. A battery pack 200 is detachably attached to the battery port 5a.

The job-site electric device 1 includes a chuck 6. The chuck 6 is situated in front of the first storage 3. Driven tools of various kinds are detachably attached to the chuck 6. Examples of the driven tools include tool bits of various kinds such as a drill bit and a driver bit.

The first storage 3 stores a power transmission mechanism (not illustrated). The power transmission mechanism transmits the rotation of the motor 40 to the chuck 6 and thereby rotates the driven tool.

The job-site electric device 1 includes a mode switch ring 8. The mode switch ring 8 is situated at a front portion of the first storage 3. The mode switch ring 8 is a rotatable member having a cylindrical shape. The mode switch ring 8 is rotated by the user of the job-site electric device 1 in order to alternatively select and set the operation mode of the job-site electric device 1 to one mode among at least two modes.

The second storage 5 stores a switch unit 10 and a controller 250 (not illustrated, see FIG. 2). The second storage 5 includes a panel opening 5b on its top surface. A top surface of the switch unit 10 is exposed to the outside of the job-site electric device 1 via the panel opening 5b. Thus, the user can operate the switch unit 10.

The switch unit 10 includes therein a switch 15, the light emitter 16, and the display 17. The switch 15 is in a form of a push button switch. The user can manually operate the switch 15 (specifically, press down the switch 15). Specifically, the user can manually and indirectly operate the switch 15 via a manually operating member 30 which will be mentioned below. The light emitter 16 emits light. The light emitter 16 includes an LED, for example. The user can visually recognize the light from the light emitter 16. The display 17 displays various information. The display 17 includes a seven-segment LED, for example. The user can visually recognize the information displayed on the display 17.

The job-site electric device 1 includes a dial 9. The dial 9 is situated at a front end of the second storage 5. The dial 9 is a rotatable member having a cylindrical shape. The dial 9 is rotated by the user in order to alternatively select and set an output torque of the motor 40 in a given mode to one of at least two torques.

In the first embodiment, the switch 15 is used to enable or disable the torque switching using the dial 9. When the torque switching is enabled, the display 17 displays the torques one by one depending on the rotation of the dial 9. The user can set a desired output torque by rotating the dial 9.

### (2-1-2) Electric Configuration of Job-Site Electric Device

As shown in FIG. 2, the motor 40 and the switch unit 10 are electrically coupled to the controller 250.

The battery pack 200 stores a battery 200a. The battery 200a is in a form of a rechargeable battery. The battery 200a may be in a form of a lithium-ion rechargeable battery.

When the battery pack 200 is attached to the battery port 5a, the battery 200a is electrically coupled to the controller 250.

The job-site electric device 1 includes a trigger input circuit 7a. The trigger input circuit 7a is mechanically coupled to the trigger 7 and outputs trigger information that shows the state of the trigger 7 to the controller 250. The trigger information includes information that shows whether the trigger 7 has been moved (or moved at least a predetermined distance) from an initial position and/or information that shows the amount of movement (or the position) of the trigger 7.

The job-site electric device 1 includes a mode input circuit 8a. The mode input circuit 8a is coupled to the mode switch ring 8 and outputs mode information that shows the position (and thus the selected mode) of the mode switch ring 8 to the controller 250.

The job-site electric device 1 includes a dial input circuit 9a. The dial input circuit 9a is coupled to the dial 9 and outputs dial information that shows the position (or a rotational speed) of the dial 9 to the controller 250.

The controller 250 includes a drive circuit 251. The drive circuit 251 is electrically coupled to the battery 200a and receives a battery power from the battery 200a. The drive circuit 251 converts the battery power to a motor driving power and supplies the motor driving power to the motor 40. In the first embodiment, the motor 40 is in a form of a brushless motor, and the motor driving power is in a form of a three-phase power.

The controller 250 includes a control circuit 252. The control circuit 252 controls the motor 40 via the drive circuit 251. The control circuit 252 receives the trigger information, the mode information, and the dial information. The control circuit 252 is electrically coupled to the switch unit 10. Specifically, the control circuit 252 is electrically coupled to the switch 15, the light emitter 16, and the display 17.

The control circuit 252 sets the torque switching to either “effective” or “ineffective” in response to the switch 15 being pressed. The control circuit 252 sets the operation mode based on the mode information. The control circuit 252 sets the output torque based on the dial information. The control circuit 252 displays information that shows the torque based on the dial information on the display 17 when the torque switching is set to “effective”. The control circuit 252 actuates the light emitter 16 (or cause the light emitter 16 to emit light) when a requirement to actuate the light emitter 16 is satisfied. When the trigger 7 is manually operated, the control circuit 252 outputs a control signal corresponding to the set operation mode and the set output torque to the drive circuit 251. In response to receiving the control signal, the drive circuit 251 supplies the motor driving power corresponding to the control signal to the motor 40 and rotates the motor 40.

### (2-1-3) Configuration of Switch Unit

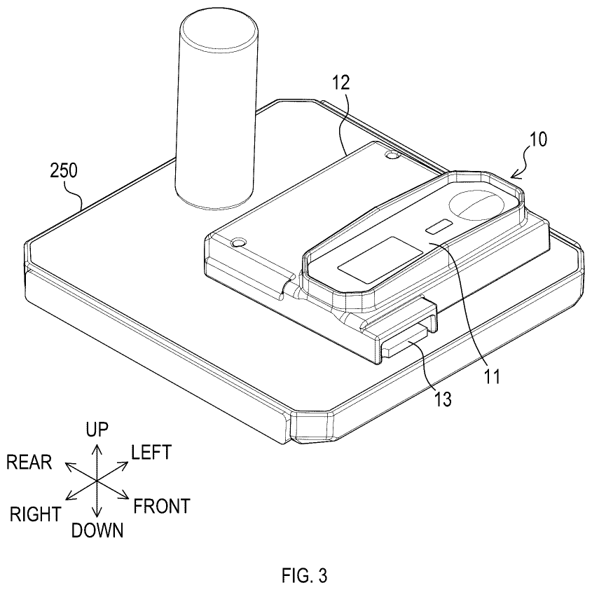

Configuration of the switch unit 10 will be explained in detail with reference to FIG. 3 to FIG. 9.

As shown in FIG. 3, the switch unit 10 is disposed on the controller 250 in the second storage 5. The switch unit 10 is electrically coupled to the controller 250 but is not fixed to the controller 250. However, the switch unit 10 may be fixed to the controller 250.

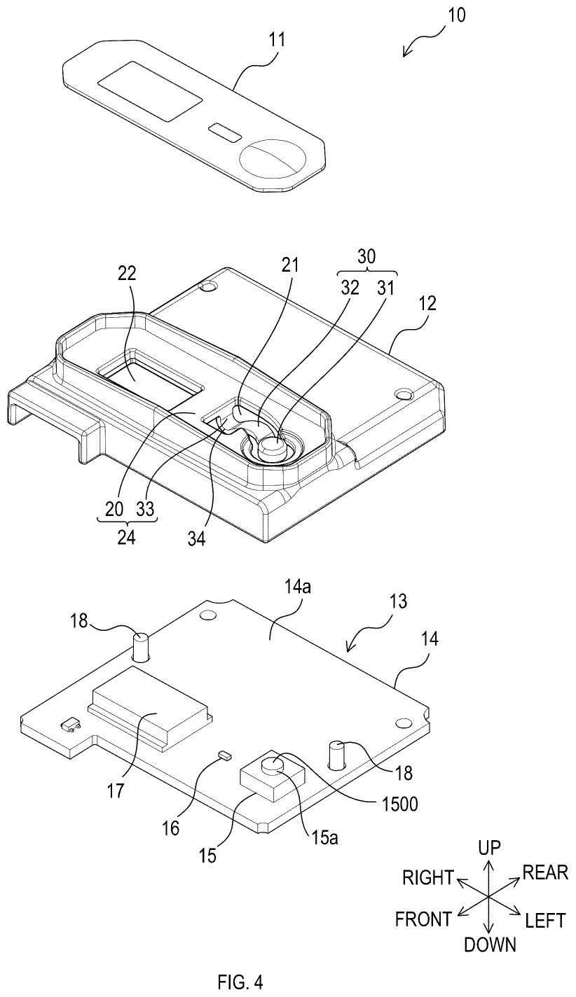

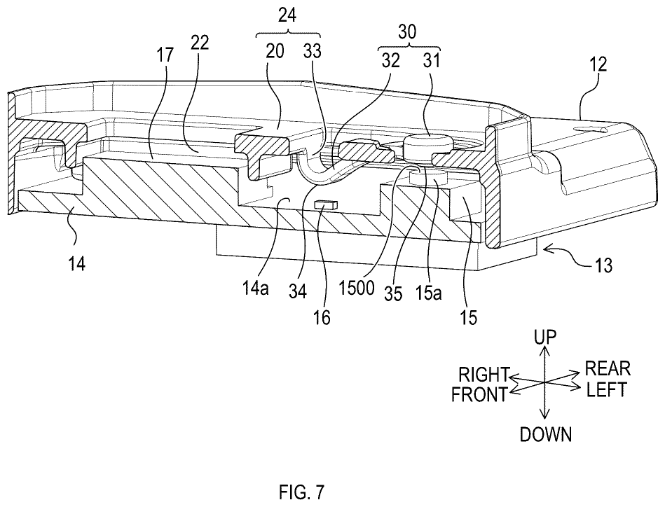

As shown in FIG. 3, FIG. 4, and FIG. 7, the switch unit 10 includes a switch circuit 13. The switch circuit 13 includes the switch 15, the light emitter 16, and the display 17.

As shown in FIG. 4 and FIG. 7, the switch circuit 13 includes a circuit board 14. The switch 15, the light emitter 16, and the display 17 are installed on a board surface 14a of the circuit board 14. The circuit board 14 includes an electric wiring (not illustrated) for coupling the switch 15, the light emitter 16, and the display 17 to the controller 250.

The switch 15 includes a movable piece 15a thereon. The “movable piece” may also be referred to as a movable portion, a push rod, an actuator, or the like. The movable piece 15a is configured to move downward and electrically turn the switch 15 on in response to receiving a first load in a downward direction. The first load may be a load of any magnitude. The act of electrically turning on the switch 15 may mean completing or interrupting a conductive path (a part of the aforementioned electric wiring) that is coupled to the switch 15. The movable piece 15a includes a switch surface 1500. The switch surface 1500 corresponds to an upper surface of the movable piece 15a. The switch surface 1500 comes in contact with an operating portion 31. The movable piece 15a (specifically the switch surface 1500) receives the first load from the operating portion 31.

As shown in FIG. 3 to FIG. 7, the switch unit 10 includes a switch plate 12. The switch plate 12 has a plate-like overall shape. More specifically, the switch plate 12 has a thin tray-like shape including a partial opening. It is merely an example, but the switch plate 12 is an integrally molded member (that is, a single member). In other words, the parts included in the switch plate 12 which will be explained below are integrally formed. The switch plate 12 may be a resin molded product that includes resin as its main component. The switch plate 12 may be integrally molded by an injection-molding method, for example.

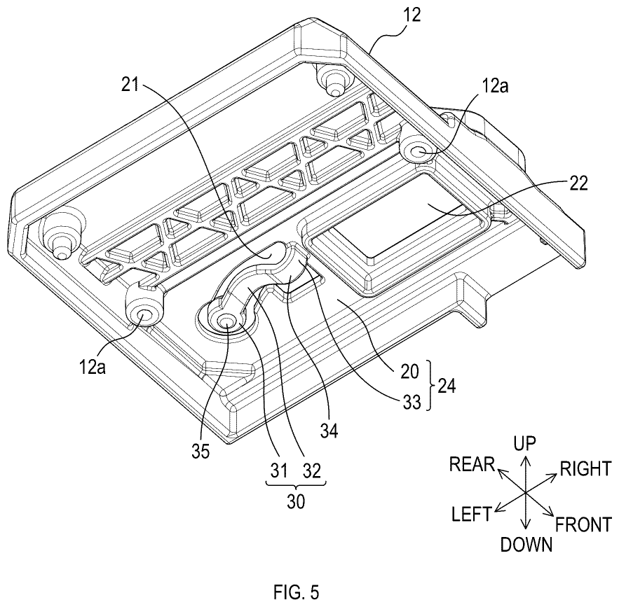

As shown in FIG. 5, the switch plate 12 includes at least two (two in the first embodiment) screw holes 12a. Each of the screw holes 12a receives a screw 18 (see FIG. 4) that is inserted therein. The switch plate 12 is fixed to the circuit board 14 by two screws 18.

As shown in FIG. 4 to FIG. 7, the switch plate 12 includes the manually operating member 30. The manually operating member 30 is manually operated by the user. More specifically, the manually operating member 30 is configured to be elastically deformed in the downward direction by being pressed in the downward direction.

The switch plate 12 includes a support body 24. The support body 24 supports the manually operating member 30.

The support body 24 includes a support member 20. The support member 20 has a plate-like shape. The “support member” may also be referred to as a support plate and the like.

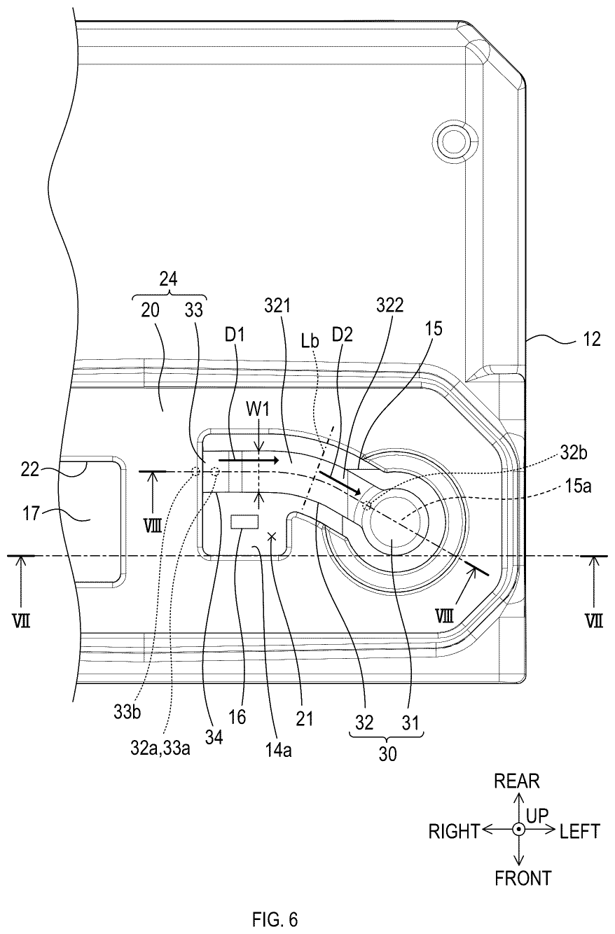

The support member 20 includes a first opening 21 that is open in up-down directions. The manually operating member 30 is situated in the first opening 21. The light emitter 16 is situated away from the first opening 21 in a downward direction. As shown in FIG. 6, when the switch plate 12 is viewed from outside in the downward direction, the light emitter 16 can be visually recognized through the first opening 21. The light emitter 16 is configured to emit light upward through the first opening 21.

The support member 20 includes a second opening 22 that is open in the up-down directions. The display 17 is situated away from the second opening 22 in the downward direction. When the switch plate 12 is viewed from outside in the downward direction, the display 17 can be visually recognized through the second opening 22.

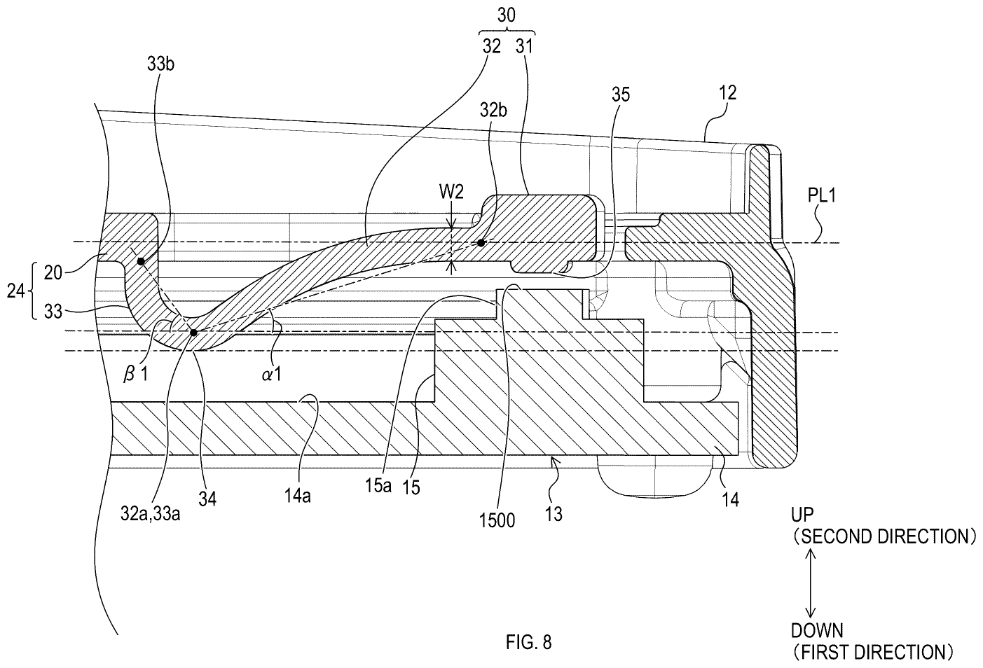

The support body 24 includes an auxiliary arm 33. The auxiliary arm 33 extends downward from the support member 20 (specifically, from an edge of the first opening 21). The auxiliary arm 33 is curved toward a first end 33a (a lower side end, see FIG. 6 and FIG. 8). A second end 33b of the auxiliary arm 33 (see FIG. 6 and FIG. 8) is coupled to the support member 20. The first end 33a and the second end 33b of the auxiliary arm 33 are respectively examples of the first auxiliary end and the second auxiliary end in the Overview of Embodiments.

The manually operating member 30 includes the operating portion 31. “The operating portion” may also be referred to as a button, a manually contacted portion, and the like. The operating portion 31 is situated away from the movable piece 15a in the upward direction. The operating portion 31 is configured to be manually moved (for example, pressed) in the downward direction by the user. The operating portion 31 includes a contact portion 35 in its lower end (see FIG. 5, FIG. 7 and FIG. 8). In response to the operating portion 31 being pressed downward, the contact portion 35 comes in contact with the switch surface 1500 of the movable piece 15a.

The manually operating member 30 includes an arm 32. The arm 32 has a long rod-like shape. More specifically, the arm 32 has an elongated and thin plate-like shape. A first end 32a of the arm 32 (see FIG. 6 and FIG. 8) is coupled to the first end 33a of the auxiliary arm 33. That is, the auxiliary arm 33 supports the arm 32 (and thus the manually operating member 30) at the first end 33a. In other words, the support member 20 supports the manually operating member 30 via the auxiliary arm 33. The first end 33a of the auxiliary arm 33 coincides with the first end 32a of the arm 32. A second end 32b of the arm 32 (see FIG. 6 and FIG. 8) is coupled to the operating portion 31.

As mentioned above, the switch plate 12 is an integrally molded member. Thus, the operating portion 31, the arm 32, the auxiliary arm 33, and the support member 20 are integrally molded. The arm 32 extends from the first end 33a of the auxiliary arm 33 along the curved shape of the auxiliary arm 33. Accordingly, the arm 32 and the auxiliary arm 33 can be deemed as a single and thin rod-like member with their boundary being bent in a U-shape. This U-shaped portion is called a bent portion 34. The bent portion 34 corresponds to the boundary between the arm 32 and the auxiliary arm 33. The bent portion 34 includes the first end 32a of the arm 32 and the first end 33a of the auxiliary arm 33.

Now, a first reference plane PL1 is defined. The first reference plane PL1 is shown in FIG. 8. The first reference plane PL1 is an imaginary plane that (i) is perpendicular to the downward direction and (ii) passes through the second end 32b of the arm 32.

As it is obvious from FIG. 6, the arm 32 of the first embodiment is bent toward the first reference plane PL1 in a midway of extending from the first end 32a to the second end 32b. In FIG. 6, the first reference plane PL1 is a surface that is parallel to the paper surface of FIG. 6.

Specifically, the arm 32 includes a initial portion 321. The initial portion 321 corresponds to a part of the arm 32 that extends from the first end 32a of the arm 32 in an extension-starting direction D1 (that is, a portion including the first end 32a). The extension-starting direction D1 is a direction extending from the first end 32a when the arm 32 is viewed from outside in the downward direction. In other words, the extension-starting direction D1 is a component of a direction parallel to the first reference plane PL1 in a direction in which the arm 32 extends from the first end 32a.

The arm 32 further includes a continuing portion 322. The continuing portion 322 corresponds to a portion of the arm 32 that extends from an end of the initial portion 321 (that is, an end opposite to the first end 32a) in an extension-continuing direction D2. The extension-continuing direction D2 is a direction extending from the end of the initial portion 321 when the arm 32 is viewed from outside in the downward direction. In other words, the extension-continuing direction D2 is a component of a direction parallel to the first reference plane PL1 in a direction in which the continuing portion 322 extends from the initial portion 321. The extension-continuing direction D2 is different from the extension-starting direction D1. A mark Lb in FIG. 6 roughly indicates a boundary between the initial portion 321 and the continuing portion 322.

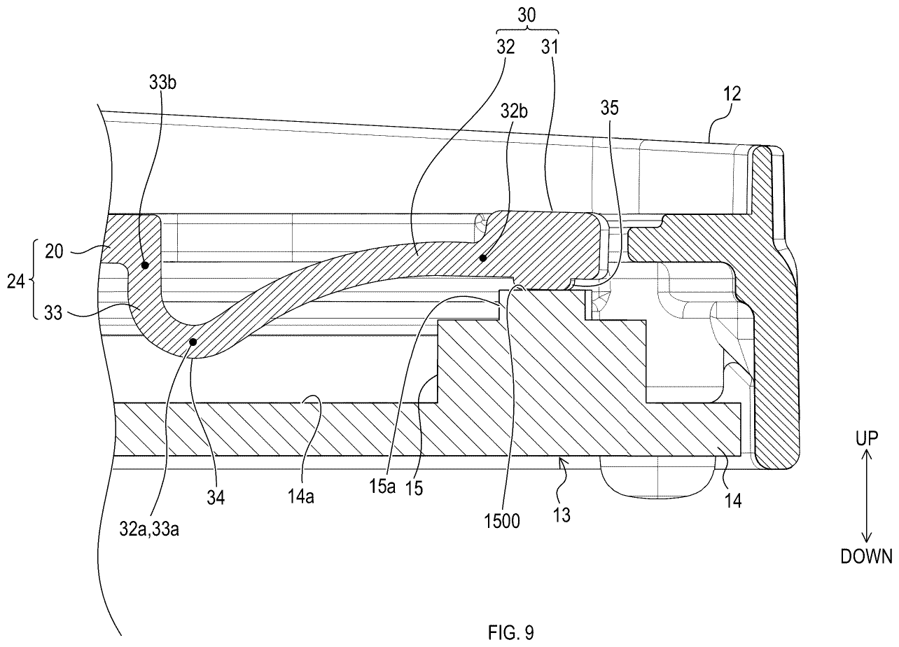

A position and movement of the manually operating member 30 will be explained in detail with reference to FIG. 8 and FIG. 9. The arm 32 extends from its first end 32a in a direction toward the first reference plane PL1. The auxiliary arm 33 also extends from its first end 33a in a direction toward the first reference plane PL1.

In the first initial state, the first end 32a of the arm 32 is situated away from the first reference plane PL1 in the downward direction. The first initial state is a state in which the manually operating member 30 is not manually moved.

In the first initial state, the arm distal-end distance is greater than or equal to the switch surface distance. The arm distal-end distance is a distance from the first reference plane PL1 to the first end 32a of the arm 32 (or to a lower edge of the first end 32a). The switch surface distance is a distance from the first reference plane PL1 to the switch surface 1500 of the movable piece 15a. The arm distal-end distance and the switch surface distance are distances along the downward direction.

Now, a first angle α1 and a second angle β1 are defined. The first angle α1 is an angle formed between the first reference plane PL1 and a main extension direction. The main extension direction is a direction from the first end 32a to the second end 32b of the arm 32. The second angle β1 is an angle formed between the first reference plane PL1 and an auxiliary extension direction. The auxiliary extension direction is a direction from the first end 33a to the second end 33b of the auxiliary arm 33. The first angle α1 is smaller than the second angle β1.

A first planar distance of the arm 32 is longer than a second planar distance of the auxiliary arm 33. The first planar distance is a distance in a direction along the first reference plane PL1 from the first end 32a to the second end 32b of the arm 32. The second planar distance is a distance in a direction along the first reference plane PL1 from the first end 33a to the second end 33b of the auxiliary arm 33.

Now, the first spring constant and the second spring constant are defined. In response to the operating portion 31 being pressed in the downward direction, a first force is applied to the auxiliary arm 33 from the operating portion 31 via the arm 32. The auxiliary arm 33 (specifically, the second end 33b and its vicinity) can be elastically deformed with respect to the support member 20 by this first force. The first spring constant shows difficulty of such an elastic deformation, in other words, difficulty of the elastic deformation of the auxiliary arm 33 with respect to the support member 20.

In response to the operating portion 31 being pressed in the downward direction, a second force is applied to the arm 32 from the operating portion 31. The arm 32 (specifically, the first end 32a and its vicinity) is elastically deformed with respect to the auxiliary arm 33 by this second force. In other words, the bent portion 34 is elastically deformed. In other words, an angle formed between the arm 32 and the auxiliary arm 33 is enlarged. The second spring constant shows difficulty of the elastic deformation of the bent portion 34.

The second spring constant is less than the first spring constant. In other words, when the operating portion 31 is pressed downward, the bent portion 34 experiences a larger elastic deformation. At this time, the auxiliary arm 33 experiences either no elastic deformation with respect to the support member 20 or an elastic deformation smaller than the elastic deformation of the bent portion 34 with respect to the support member 20.

A width W1 of the arm 32 (see FIG. 6) is at least twice a thickness W2 of the arm 32 (see FIG. 8). Accordingly, the arm 32 is inhibited or prevented from being twisted when the operating portion 31 is pressed by the user.

According to such a configuration, in response to the operating portion 31 being pressed in the downward direction, the operating portion 31 is displaced in the downward direction together with the arm 32 about the bent portion 34 as the fulcrum. In other words, the bent portion 34 is elastically deformed to thereby cause the manually operating member 30 to be displaced in the downward direction.

This causes the operating portion 31 to come in contact with the switch surface 1500 of the movable piece 15a, and the first load is applied to the movable piece 15a from the operating portion 31 as illustrated in FIG. 9. At this time, a vector of a force (i.e., the first load) applied to the movable piece 15a coincides with the downward direction or contains a lot of components of the downward direction. In other words, a large portion or all of the force applied to the movable piece 15a contributes to the downward movement of the movable piece 15a as the first load.

Main causes of the vector to have such a character are as follows: in the first initial state, (i) the first end 32a of the arm 32 is situated below the first reference plane PL1; (ii) the arm distal-end distance is greater than or equal to the switch surface distance; and (iii) the second spring constant is smaller than the first spring constant. As a result of the vector having such a character, the force applied to the operating portion 31 by the user is efficiently transmitted to the movable piece 15a. This also enables the user to operate the switch 15 with less force, which improves operability and usability for the user. It is also possible to reduce stress applied to the switch plate 12, which then reduces or prevents defects such as breakage of the switch plate 12.

In response to the first load being applied from the operating portion 31 to the movable piece 15a, the movable piece 15a is moved downward. The switch 15 is thus turned on. Subsequently, as the operating portion 31 leaves the movable piece 15a, the movable piece 15a is moved upward and returns to the first initial state. The switch 15 is thus turned off.

Each of the first end 32a and the second end 32b of the arm 32 may be defined in any way. The first end 32a may be an entire cross-section of a boundary with the auxiliary arm 33 or may be a portion of the cross-section of the boundary. In the first embodiment, the first end 32a corresponds to a central portion of the cross-section of the boundary. The first end 32a may be a lower end of the cross-section of the boundary (that is, a lower end of the bent portion 34), for example. Similarly, the second end 32b of the arm 32 may be defined as any portion of a boundary with the operating portion 31. The first end 33a of the auxiliary arm 33 may also be defined as any portion of a boundary with the arm 32. The second end 33b of the auxiliary arm 33 may also be defined as any portion of a boundary with the support member 20.

As shown in FIG. 3 and FIG. 4, the switch unit 10 includes a label 11. In order to facilitate understanding of the structure of the switch unit 10, the label 11 is omitted in FIG. 6 to FIG. 9. The label 11 covers an entirety of a top surface of the support member 20 on the switch plate 12. The label 11 inhibits or prevents damage to the switch plate 12 and entry of dust or the like into the switch plate 12 from outside. Strictly speaking, the operating portion 31 is pressed by the user via the label 11. The label 11 has a light transmittance of a certain level or higher. The label 11 may be transparent or semitransparent. The light from the light emitter 16 and information displayed on the display 17 are visually recognized through the label 11. The label 11 is not essential and may be omitted.

### 2-2. Second Embodiment

The second embodiment provides a job-site electric device 50 that is in a form of a handheld vacuum cleaner. However, such a job-site electric device 50 is also merely an example.

### (2-2-1) Overall Configuration of Job-Site Electric Device

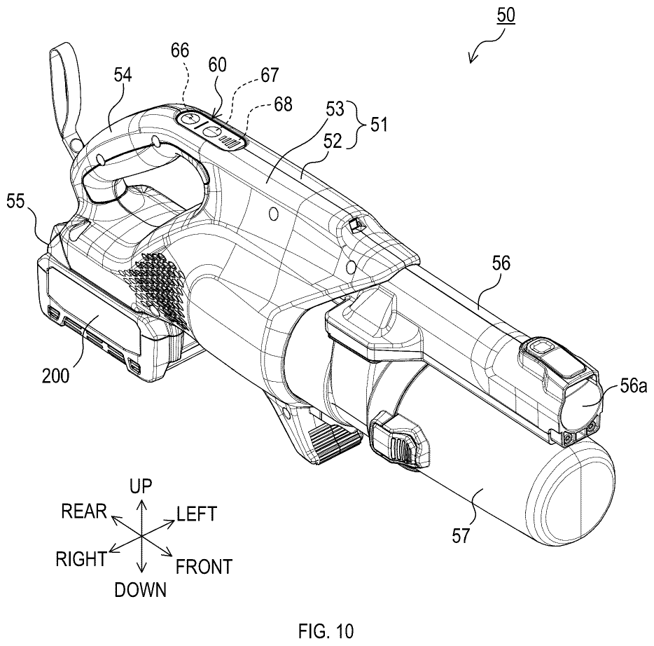

As shown in FIG. 10, the job-site electric device 50 includes a housing 51. The housing 51 includes a first housing 52 and a second housing 53. The housing 51 is roughly equally divided into two portions, one of which corresponds to the first housing 52 and the other one of which corresponds to the second housing 53. The housing 51 is assembled by combining the first housing 52 and the second housing 53.

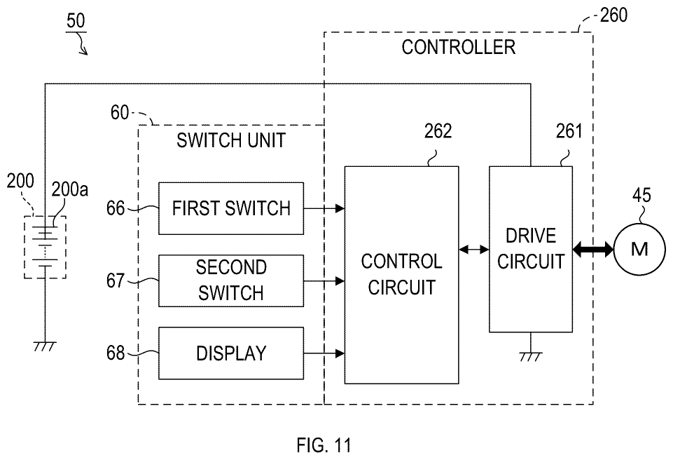

The housing 51 houses a motor 45 (not illustrated, see FIG. 11), a controller 260 (not illustrated, see FIG. 11), and a switch unit 60.

The housing 51 includes a grip 54. The grip 54 is held by the user of the job-site electric device 50.

The housing 51 includes a battery port 55 in its lower rear end. The battery pack 200 is detachably attached to the battery port 55.

The job-site electric device 50 includes a suction unit 56. An end of the suction unit 56 includes an insertion opening 56a. A suction pipe (not illustrated) is detachably attached to the insertion opening 56a. As the motor 45 rotates, outside air (which may include dust or the like) is sucked from the insertion opening 56a into the suction unit 56. The suction unit 56 can separate the dust or the like from the sucked air.

The job-site electric device 50 includes a dust case 57. The dust case 57 stores the dust or the like separated by the suction unit 56 The housing 51 includes an opening in its top surface. The top surface of the switch unit 60 is exposed to the outside of the job-site electric device 50 via the opening. Thus, the user can operate the switch unit 60.

The switch unit 60 includes therein a first switch 66, a second switch 67, and a display 68. The first switch 66 and the second switch 67 are in a form of a push button switch. In the second embodiment, as an example, the first switch 66 and the second switch 67 have the same shape, structure, and size as each other. As a further example, the first switch 66 and the second switch 67 have the same shape, structure, and size as the switch 15 in the first embodiment.

If the first switch 66 is pressed when the motor 45 is stopped, the motor 45 rotates. If the first switch 66 is pressed when the motor 45 is rotating, the motor 45 stops.

The second switch 67 is used to set a suction force to one of multiple levels. Every time the second switch 67 is pressed, the suction force is switched in sequence.

The display 68 displays various information. The display 68 includes at least two LEDs that are arranged in a fixed (for example, forward) direction, for example. The user can visually recognize information displayed on the display 68. The display 68 displays information corresponding to the set suction force, for example.

### (2-2-2) Electric Configuration of Job-Site Electric Device

As shown in FIG. 11, the motor 45 and the switch unit 60 are electrically coupled to the controller 260.

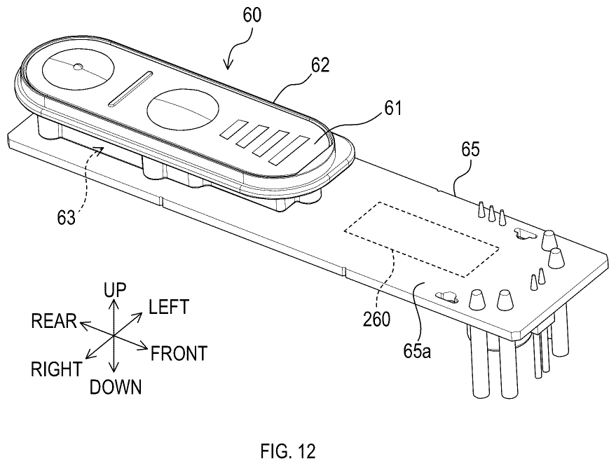

The job-site electric device 50 of the second embodiment includes the circuit board 65 (see FIG. 12) as described below in detail. The circuit board 65 includes the switch unit 60 and the controller 260. In other words, the switch unit 60 and the controller 260 are mounted on the same single board.

As the battery pack 200 is attached to the battery port 55, the battery 200a is electrically coupled to the controller 260.

The controller 260 includes a drive circuit 261. The drive circuit 261 is electrically coupled to the battery 200a and receives a battery power from the battery 200a. The drive circuit 261 converts the battery power to a motor driving power and supplies the motor driving power to the motor 45. In the second embodiment, the motor 45 is in a form of a brushless motor, and the motor driving power is in a form of a three-phase power.

The controller 260 includes a control circuit 262. The control circuit 262 controls the motor 45 via the drive circuit 261. The control circuit 262 is electrically coupled to the switch unit 60. Specifically, the control circuit 262 is electrically coupled to the first switch 66, the second switch 67, and the display 68.

The control circuit 262 activates or stops the motor 45 in response to the first switch 66 being pressed. The control circuit 262 switches the suction force in response to the second switch 67 being pressed and displays information indicating the switched suction force on the display 68.

### (2-2-3) Configuration of Switch Unit

The configuration of the switch unit 60 will be explained in detail with reference to FIG. 12 to FIG. 17.

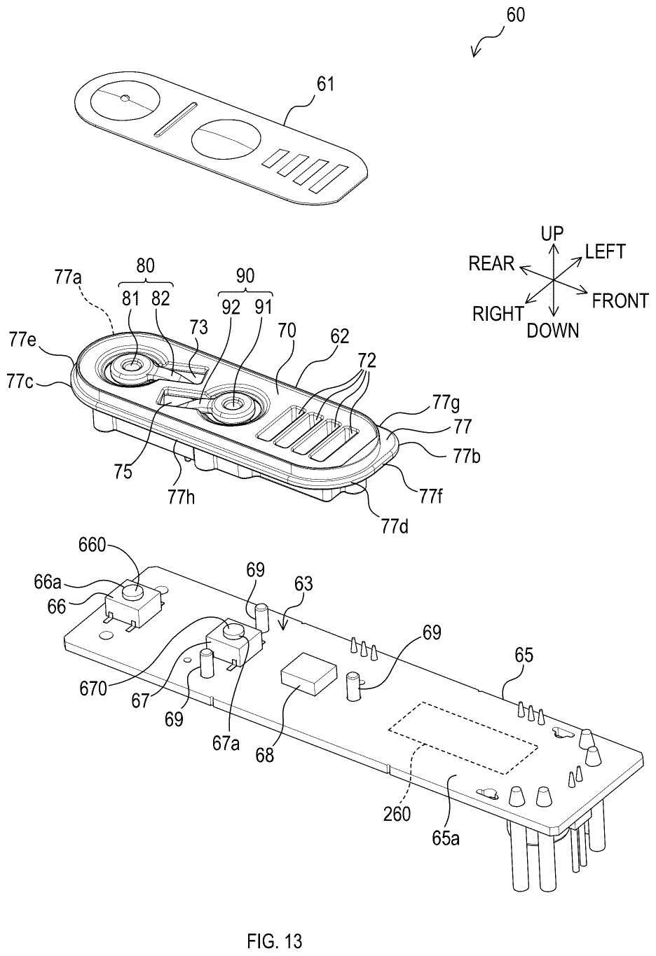

As shown in FIG. 12 and FIG. 13, the switch unit 60 includes a switch circuit 63. The switch circuit 63 includes the first switch 66, the second switch 67, and the display 68. As mentioned above, the job-site electric device 50 includes the circuit board 65. The first switch 66, the second switch 67, and the display 68 are mounted on a board surface 65a of the circuit board 65. The circuit board 65 includes electric wiring (not illustrated) to couple the first switch 66, the second switch 67, and the display 68 to the controller 260.

As mentioned above, the first switch 66 and the second switch 67 are configured in the same manner as the switch 15 in the first embodiment. Thus, the explanation of the switch 15 provided above likewise applies to the first switch 66 and the second switch 67.

That is, the first switch 66 includes the first movable piece 66a on its upper portion. The first movable piece 66a corresponds to the movable piece 15a in the first embodiment. The first movable piece 66a includes a switch surface 660. The switch surface 660 corresponds to an upper surface of the first movable piece 66a. The switch surface 660 comes in contact with a first operating portion 81. The first operating portion 81 corresponds to the operating portion 31 in the first embodiment.

The second switch 67 includes a second movable piece 67a on its upper portion. The second movable piece 67a corresponds to the movable piece 15a in the first embodiment. The second movable piece 67a includes a switch surface 670. The switch surface 670 corresponds to an upper surface of the second movable piece 67a. The switch surface 670 comes in contact with the second operating portion 91. The second operating portion 91 corresponds to the operating portion 31 in the first embodiment. The second movable piece 67a is configured to move in the downward direction and electrically turn on the second switch 67 in response to receiving a second load in the downward direction. The second load may be a load of any magnitude. In the second embodiment, the second load is the same as the first load.

As shown in FIG. 12 to FIG. 15, the switch unit 60 includes a switch plate 62. The switch plate 62 has a plate-like overall shape. More specifically, the switch plate 62 has a thin tray-like shape including a partial opening. It is merely an example, but the switch plate 62 is an integrally molded member. In other words, the parts included in the switch plate 62 which will be explained below are integrally formed. The switch plate 62 may be a resin molded product that includes resin as its main component.

The switch plate 62 includes at least two screw holes (not illustrated). Each of the screw holes receives a screw 69 (see FIG. 13) that is inserted therein. The switch plate 62 is fixed to the circuit board 65 by at least two screws 69.

As shown in FIG. 13 to FIG. 15, the switch plate 62 includes a first manually operating member 80. When comparing the first manually operating member 80 to the manually operating member 30 in the first embodiment, the shape and the size of a first arm 82 are slightly different from those of the arm 32. The first arm 82 corresponds to the arm 32 in the first embodiment. Except for the first arm 82, the first manually operating member 80 has basically the same configuration and function as the manually operating member 30. In other words, the first manually operating member 80 is configured to be elastically deformed in the downward direction by being pressed in the downward direction by the user.

The switch plate 62 further includes a second manually operating member 90. The second manually operating member 90 has the same shape, structure, and size as the first manually operating member 80 and functions in the same manner as the first manually operating member 80.

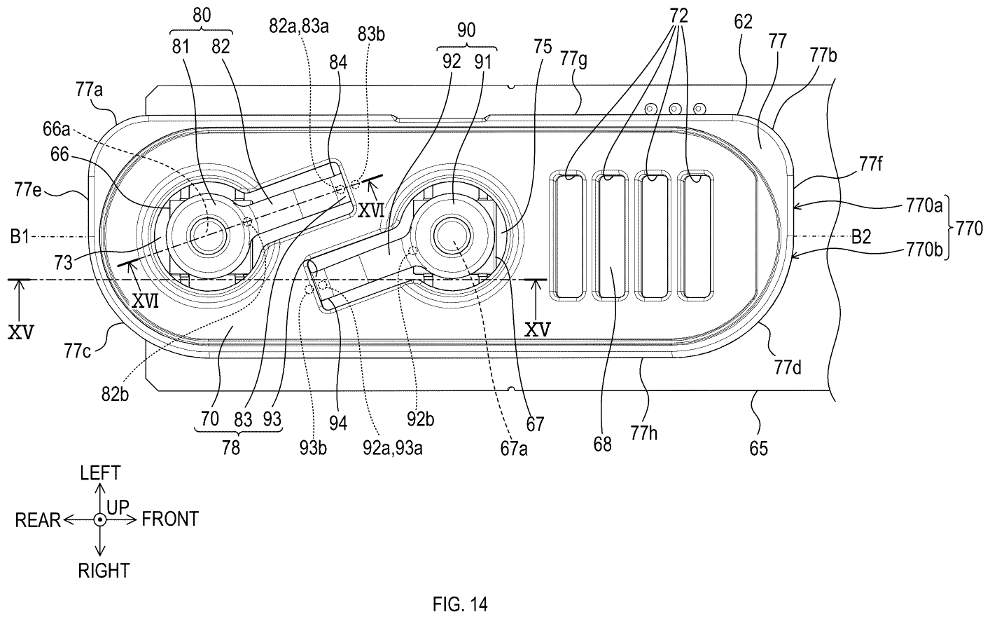

As shown in FIG. 14, the switch plate 62 includes a support body 78. The support body 78 supports the first manually operating member 80 and the second manually operating member 90.

The support body 78 includes a support member 70. The support member 70 has a plate-like shape. The support member 70 includes a first opening 73 that is open in the up-down directions. The first manually operating member 80 is situated in the first opening 73. The support member 70 includes a second opening 75 that is open in the up-down directions. The second manually operating member 90 is situated in the second opening 75.

The support member 70 includes at least one third openings 72 that are open in the up-down directions. In the second embodiment, the support member 70 includes four third openings 72. The display 68 is situated away from the third openings 72 in the downward direction. When the switch plate 62 is viewed from outside in the downward direction, the display 68 can be visually recognized through the third openings 72.

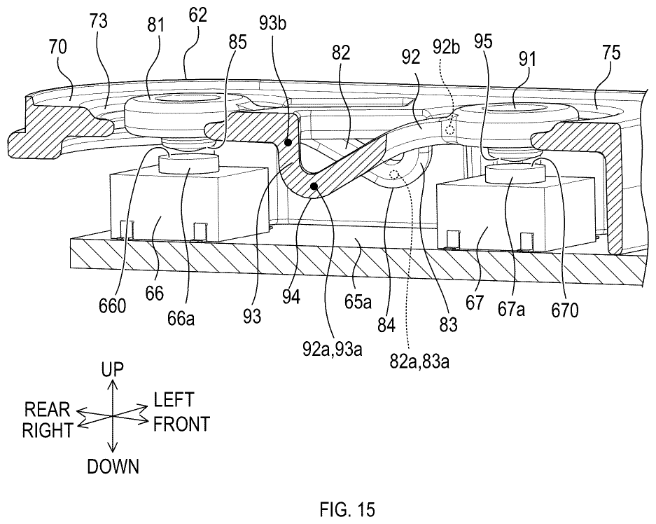

As shown in FIG. 14 and FIG. 15, the support body 78 includes a first auxiliary arm 83. The first auxiliary arm 83 basically has the same shape, structure, and size as the auxiliary arm 33 in the first embodiment and functions in the same manner as the auxiliary arm 33. In other words, the first auxiliary arm 83 extends downward from the support member 70 (specifically, from an edge of the first opening 73). A first end 83a of the first auxiliary arm 83 is curved. The second end 83b of the first auxiliary arm 83 is coupled to the support member 70.

The first manually operating member 80 includes a first operating portion (or a first button) 81. The first operating portion 81 basically has the same shape, structure, and size as the operating portion 31 in the first embodiment and functions in the same manner as the operating portion 31. In other words, the first operating portion 81 is situated away from the first movable piece 66a in the upward direction. The first operating portion 81 includes a contact portion 85 in its lower end (see FIG. 15). In response to the first operating portion 81 being pressed downward, the contact portion 85 comes in contact with the switch surface 660 of the first movable piece 66a.

The first manually operating member 80 includes the first arm 82. The first arm 82 is slightly different from the arm 32 in the first embodiment in its shape and size, however, the first arm 82 basically functions in the same manner as the arm 32.

In other words, the first arm 82 has a long rod-like shape. More specifically, the first arm 82 has an elongated and thin plate-like shape. A first end 82a of the first arm 82 is coupled to the first end 83a of the first auxiliary arm 83. In other words, the first auxiliary arm 83 supports the first arm 82 (and thus the first manually operating member 80) at the first end 83a. The first end 83a of the first auxiliary arm 83 coincides with the first end 82a of the first arm 82. A second end 82b of the first arm 82 is coupled to the first operating portion 81.

As shown in FIG. 14 and FIG. 15, the support body 78 includes a second auxiliary arm 93. The second auxiliary arm 93 has the same shape, structure, and size as the first auxiliary arm 83 and functions in the same manner as the first auxiliary arm 83. In other words, the second auxiliary arm 93 extends downward from the support member 70 (specifically, from an edge of the second opening 75). A first end 93a of the second auxiliary arm 93 is curved. A second end 93b of the second auxiliary arm 93 is coupled to the support member 70.

The second manually operating member 90 includes a second operating portion (or a second button) 91. The second operating portion 91 has the same shape, structure, and size as the first operating portion 81 and functions in the same manner as the first operating portion 81. In other words, the second operating portion 91 is situated away from the second movable piece 67a in the upward direction. The second operating portion 91 includes a contact portion 95 in its lower end (see FIG. 15). In response to the second operating portion 91 being pressed downward, the contact portion 95 comes in contact with the switch surface 670 of the second movable piece 67a.

The second manually operating member 90 includes a second arm 92. The second arm 92 has the same shape, structure, and size as the first arm 82 and functions in the same manner as the first arm 82. A first end 92a of the second arm 92 is coupled to the first end 93a of the second auxiliary arm 93. In other words, the second auxiliary arm 93 supports the second arm 92 (and thus the second manually operating member 90) at the first end 93a. The first end 93a of the second auxiliary arm 93 coincides with the first end 92a of the second arm 92. A second end 92b of the second arm 92 is coupled to the second operating portion 91.

As mentioned above, the switch plate 62 is an integrally molded member. Thus, the first manually operating member 80, the first auxiliary arm 83, the second manually operating member 90, the second auxiliary arm 93, and the support member 70 are integrally molded.

The first arm 82 extends from the first end 83a of the first auxiliary arm 83 so as to continuously follow the curved shape of the first end 83a. A boundary between the first arm 82 and the first auxiliary arm 83 is referred to as a first bent portion 84. The first bent portion 84 has a shape that is bent in a U-shape. The first bent portion 84 includes the first end 82a of the first arm 82 and the first end 83a of the first auxiliary arm 83.

The second arm 92 extends from the first end 93a of the second auxiliary arm 93 so as to continuously follow the curved shape of the first end 93a. A boundary between the second arm 92 and the second auxiliary arm 93 is referred to as a second bent portion 94. The second bent portion 94 has a shape that is bent in a U-shape. The second bent portion 94 includes the first end 92a of the second arm 92 and the first end 93a of the second auxiliary arm 93.

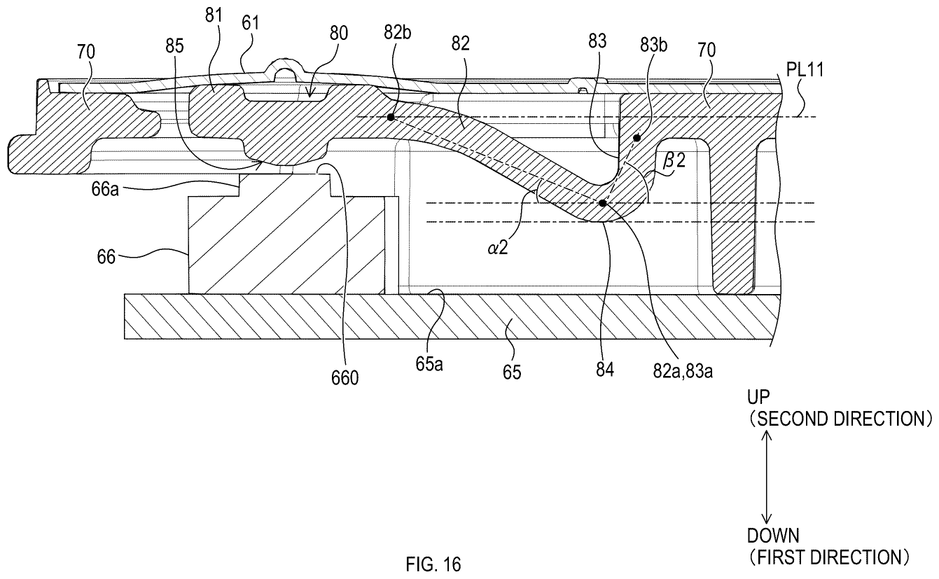

Now, a first reference plane PL11 and a second reference plane are defined. The first reference plane PL11 is illustrated in FIG. 16. The first reference plane PL11 is an imaginary plane that (i) is perpendicular to the downward direction and (ii) passes through the second end 82b of the first arm 82. The second reference plane is an imaginary plane that (i) is perpendicular to the downward direction and (ii) passes through the second end 92b of the second arm 92. In the second embodiment, the second reference plane coincides with the first reference plane PL11. Accordingly, in the following description in the second embodiment, the first reference plane PL11 and the second reference plane are simply referred to as “reference planes”.

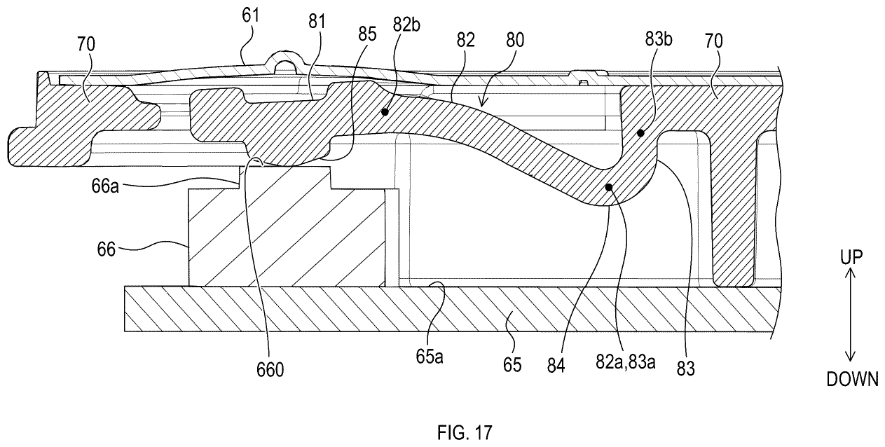

Positions and movements of the first manually operating member 80 and the second manually operating member 90 will be explained in detail with reference to FIG. 16 and FIG. 17.

The first arm 82 extends from its first end 82a in a direction approaching the reference planes. The first auxiliary arm 83 also extends from its first end 83a in a direction approaching the reference planes.

In the second initial state, the first end 82a of the first arm 82 is situated away from the reference planes in the downward direction. The second initial state is a state in which the first manually operating member 80 and the second manually operating member 90 are not manually moved.

In the second initial state, a first arm distal-end distance is greater than or equal to a first switch surface distance. The first arm distal-end distance is a distance from the reference planes to the first end 82a of the first arm 82 (or to the lower edge of the first end 82a). The first switch surface distance is a distance from the reference planes to the switch surface 660 of the first movable piece 66a. The first arm distal-end distance and the first switch surface distance are along the downward direction (or the upward direction).

Now, a first angle α2 and a second angle β2 are defined. The first angle α2 is an angle formed between the reference planes and the main extension direction. The main extension direction is a direction from the first end 82a of the first arm 82 to the second end 82b of the first arm 82. The second angle β2 is an angle formed between the reference planes and the auxiliary extension direction. The auxiliary extension direction is a direction from the first end 83a of the first auxiliary arm 83 to the second end 83b of the first auxiliary arm 83. The first angle α2 is smaller than the second angle β2.

The first planar distance of the first arm 82 is longer than the second planar distance of the first auxiliary arm 83. The first planar distance is a distance along the reference planes from the first end 82a to the second end 82b of the first arm 82. The second planar distance is a distance along the reference planes from the first end 83a to the second end 83b of the first auxiliary arm 83.

Now, the first spring constant and the second spring constant are defined also in the second embodiment. In response to the first operating portion 81 being pressed in the downward direction, a third force is applied to the first auxiliary arm 83 from the first operating portion 81 via the first arm 82. The first auxiliary arm 83 (specifically, the second end 83b and its vicinity) can be elastically deformed with respect to the support member 70 by this third force. The first spring constant shows difficulty of such an elastic deformation, in other words, difficulty of the elastic deformation of the first auxiliary arm 83 with respect to the support member 70.

In response to the first operating portion 81 being pressed in the downward direction, a fourth force is applied to the first arm 82 from the first operating portion 81. The first arm 82 (specifically, the first end 82a and its vicinity) is elastically deformed with respect to the first auxiliary arm 83 by this fourth force. In other words, the first bent portion 84 is elastically deformed. In other words, an angle formed between the first arm 82 and the first auxiliary arm 83 is enlarged. The second spring constant shows difficulty of the elastic deformation of the first bent portion 84.

The second spring constant is smaller than the first spring constant. In other words, when the first operating portion 81 is pressed downward, the first bent portion 84 experiences a larger elastic deformation. At this time, the first auxiliary arm 83 experiences either no elastic deformation with respect to the support member 70 or an elastic deformation smaller than the elastic deformation of the first bent portion 84 with respect to the support member 70.

Similarly to the arm 32 in the first embodiment, the width of the first arm 82 is at least twice the thickness of the first arm 82. According to such a configuration, in response to the first operating portion 81 being pressed in the downward direction, the first operating portion 81 is displaced in the downward direction together with the first arm 82 about the first bent portion 84 as the fulcrum. In other words, the first bent portion 84 is elastically deformed to thereby cause the first manually operating member 80 to be displaced in the downward direction.

As illustrated in FIG. 17, this causes the first operating portion 81 to come in contact with the switch surface 660 of the first movable piece 66a, and the first load is applied to the first movable piece 66a from the first operating portion 81. At this time, a vector of a force applied to the first movable piece 66a coincides with the downward direction or contains a lot of components of the downward direction. In other words, a large portion or all of the force applied to the first movable piece 66a contributes to the downward movement of the first movable piece 66a as the first load.

In response to the first load being applied to the first movable piece 66a from the first operating portion 81, the first movable piece 66a moves downward. The first switch 66 is thus turned on. As the first operating portion 81 leaves the first movable piece 66a, the first movable piece 66a which was moved downward is moved upward and returns to the second initial state. The first switch 66 is thus turned off.

Similarly to the first end 32a and the second end 32b of the arm 32 in the first embodiment, the first end 82a and the second end 82b of the first arm 82 may be defined in any way. The same applies to the first end 92a and the second end 92b of the second arm 92. Similarly to the first end 33a and the second end 33b of the auxiliary arm 33 in the first embodiment, the first end 83a and the second end 83b of the first auxiliary arm 83 may be defined in any way. The same applies to the first end 93a and the second end 93b of the second auxiliary arm 93.

The aforementioned description in relation to the position and movement of the first manually operating member 80 similarly applies to the second manually operating member 90. In other words, in the second initial state, the first end 92a of the second arm 92 is situated away from the reference planes in the downward direction. In the second initial state, a second arm distal-end distance is greater than or equal to a second switch surface distance. The second arm distal-end distance is a distance from the reference planes to the first end 92a of the second arm 92 (or to a lower edge of the first end 92a). The second switch surface distance is a distance from the reference planes to the switch surface 670 of the second movable piece 67a. The second arm distal-end distance and the second switch surface distance are distances along the downward direction (or the upward direction). Other characteristics of the first manually operating member 80 (for example, relationship between various distances mentioned above, relationship between the first angle α2 and the second angle β2, the spring constant, and the width and the thickness of the first arm 82) are similarly possessed by the second manually operating member 90.

According to such a configuration, in response to the second operating portion 91 being pressed in the downward direction, the second operating portion 91 is displaced in the downward direction together with the second arm 92 about the second bent portion 94 as the fulcrum. As illustrated in FIG. 17, this causes the second operating portion 91 to come in contact with the switch surface 670 of the second movable piece 67a, and the second load is applied to the second movable piece 67a from the second operating portion 91. The characteristics of the vector of the force (i.e., the second load) applied to the second movable piece 67a at this time are also similar to the characteristics of the vector of the force applied to the first movable piece 66a.

As shown in FIG. 12, FIG. 13, FIG. 16, and FIG. 17, the switch unit 60 includes a label 61. In order to facilitate understanding of the structure of the switch unit 60, the label 61 is omitted in FIG. 14 and FIG. 15. The label 61 covers an entirety of a top surface of the support member 70 on the switch plate 62. The material (or composition) of the label 61 is basically the same as that of the label 11 in the first embodiment, and the label 61 is used for the same purpose as the label 11 is.

### (2-2-4) Fixing of Switch Unit to Housing

A configuration to support the switch unit 60 in the housing 51 will be explained.

As shown in FIG. 13 and FIG. 14 (particularly FIG. 14), the switch plate 62 includes a flange (or a rib) 77 that is disposed along its outer circumference 770. The flange 77 can be deemed as a part of the support body 78. In other words, it may also be described that the support body 78 includes the flange 77 along its outer circumference 770.

The outer circumference 770 of the flange 77 (that is, an outer circumference of the support body 78, and thus is an outer circumference of the switch plate 62) includes a first curved area 77a, a second curved area 77b, a third curved area 77c, and a fourth curved area 77d. The first to the fourth curved areas 77a, 77b, 77c, and 77d are curved areas on the outer circumference 770 of the flange 77.

A curvature of the first curved area 77a is greater than a curvature of the third curved area 77c and a curvature of the fourth curved area 77d. A curvature of the second curved area 77b is greater than the curvature of the third curved area 77c and the curvature of the fourth curved area 77d. In the second embodiment, the curvature of the first curved area 77a is equal to the curvature of the second curved area 77b, and the curvature of the third curved area 77c is equal to the curvature of the fourth curved area 77d.

The outer circumference 770 of the flange 77 includes a first linear area 77e, a second linear area 77f, a third linear area 77g, and a fourth linear area 77h.

The first linear area 77e is a linear area between the first curved area 77a and the third curved area 77c. The second linear area 77f is a linear area between the second curved area 77b and the fourth curved area 77d. The third linear area 77g is a linear area between the first curved area 77a and the second curved area 77b. The fourth linear area 77h is a linear area between the third curved area 77c and the fourth curved area 77d.

Now, on the outer circumference 770 of the flange 77, a first outer circumferential portion 770a and a second outer circumferential portion 770b will be defined. The outer circumference 770 of the flange 77 is divided into the first outer circumferential portion 770a and the second outer circumferential portion 770b at a first border B1 and a second border B2 (see FIG. 14). The first outer circumferential portion 770a extends from the first border B1 to the second border B2 by passing the first curved area 77a, the third linear area 77g, and the second curved area 77b. The second outer circumferential portion 770b extends from the first border B1 to the second border B2 by passing the third curved area 77c, the fourth linear area 77h, and the fourth curved area 77d. The first border B1 is on the first linear area 77e. The second border B2 is on the second linear area 77f. In the first linear area 77e, a length from the first border B1 to the first curved area 77a is greater than a length from the first border B1 to the third curved area 77c. In the second linear area 77f, a length from the second border B2 to the second curved area 77b is greater than a length from the second border B2 to the fourth curved area 77d.

The shape of the first outer circumferential portion 770a is different from the shape of the second outer circumferential portion 770b. In other words, the first outer circumferential portion 770a and the second outer circumferential portion 770b are asymmetric to each other.

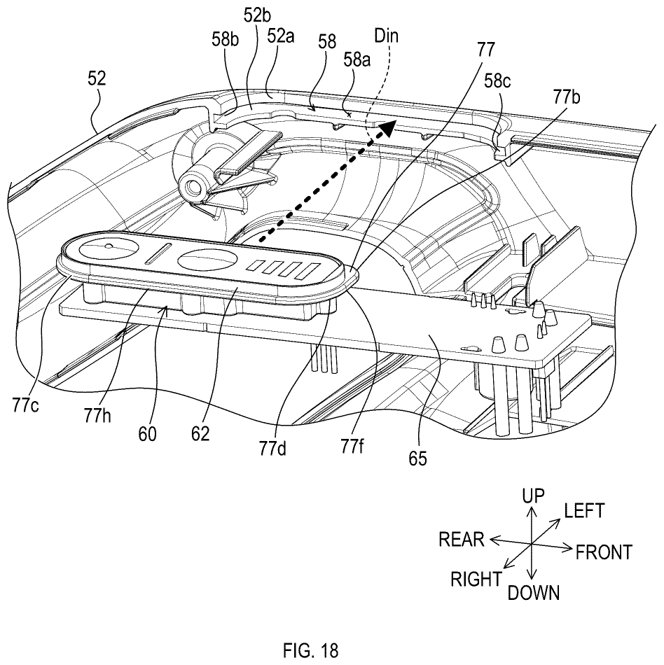

As shown in FIG. 18, the first housing 52 includes a first support portion 58. The first support portion 58 has a groove-like shape. The first support portion 58 includes a fit-in space 58a. Specifically, the first support portion 58 includes a first rib 52a and a second rib 52b. The fit-in space 58a corresponds to a space between the first rib 52a and the second rib 52b. The first outer circumferential portion 770a of the flange 77 is fitted into the fit-in space 58a.

In the process of manufacturing the job-site electric device 50, the switch plate 62 is fitted into the first support portion 58 in a fitting direction Din in the unassembled state. The unassembled state is a state in which the switch plate 62 is not attached to the housing 51, and the second housing 53 is situated away from the first housing 52.

The first support portion 58 includes a first guide 58b and a second guide 58c. The first guide 58b and the second guide 58c are situated along the fitting direction Din. The first linear area 77e and the second linear area 77f are parallel to the fitting direction Din.

In the unassembled state, as the switch plate 62 is fitted into the fit-in space 58a in the fitting direction Din from the first outer circumferential portion 770a, the switch plate 62 is moved in the fitting direction Din while being guided by the first guide 58b and the second guide 58c.

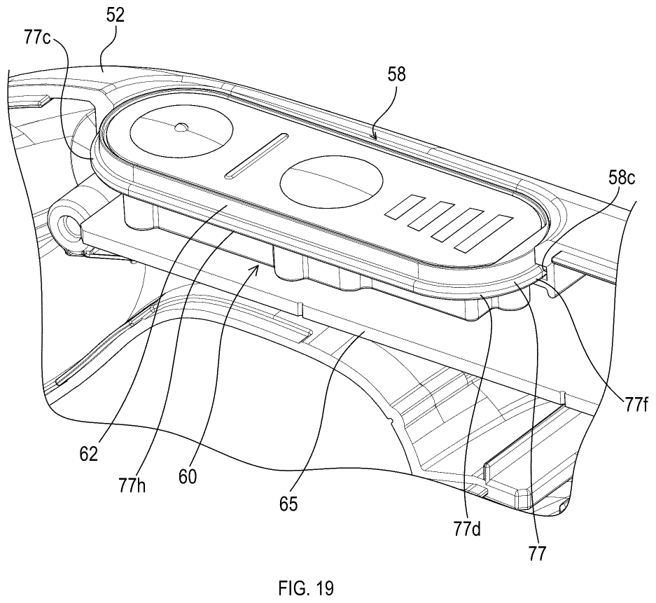

And, as shown in FIG. 19, the entirety of the first outer circumferential portion 770a is fitted into the fit-in space 58a, by which the switch plate 62 is temporarily assembled to (that is, temporarily supported by) the housing 51. In other words, the switch plate 62 (and thus the switch unit 60) is brought into a semifixed state. At this time, the second outer circumferential portion 770b is situated outside of the fit-in space 58a.

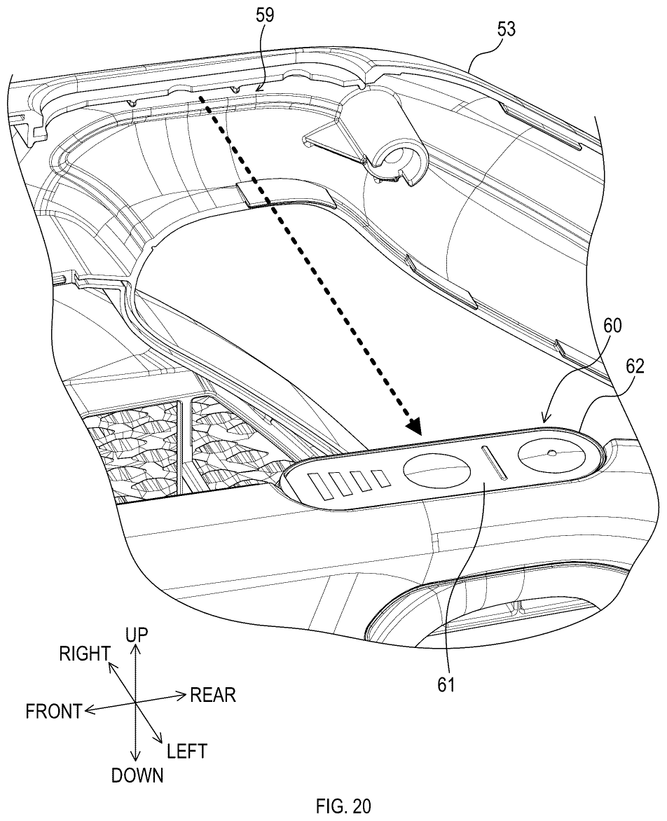

In the second embodiment, a half or more of the first linear area 77e and a half or more of the second linear area 77f are in the fit-in space 58a in the semifixed state. After being temporarily assembled, as shown in FIG. 20, the second housing 53 is assembled to the first housing 52. The second housing 53 includes a second support portion 59. The second support portion 59 has a structure similar to the structure of the first support portion 58. As the second housing 53 is assembled to the first housing 52, the second outer circumferential portion 770b of the flange 77 of the switch plate 62 is fitted into the second support portion 59. The switch plate 62 is thereby fixed to the housing 51.

In the second embodiment, the shape of the second outer circumferential portion 770b is different from the shape of the first outer circumferential portion 770a. Thus, it is possible to easily and properly assemble the switch plate 62 to the first housing 52. In other words, it is possible to inhibit or prevent an attempt of fitting the second outer circumferential portion 770b into the first housing 52 by mistake, for example.

The first linear area 77e and the second linear area 77f are parallel to the fitting direction Din. Thus, it is possible to easily fit the switch plate 62 into the first housing 52. It is also possible to make the switch plate 62 that is fitted into the first housing 52 difficult to come off from the first housing 52.

The curvature of the first curved area 77a and the curvature of the second curved area 77b are greater than the curvature of the third curved area 77c and the curvature of the fourth curved area 77d. Thus, it is possible to easily assemble the second housing 53 to the first housing 52 in the semifixed state. In other words, it is possible to easily fit the second outer circumferential portion 770b of the switch plate 62 into the second support portion 59 of the second housing 53. The following is a supplementary explanation of such effects. The greater the curvatures of the third and the fourth curved areas 77c and 77d (in other words, the smaller the radius of curvatures of the third and the fourth curved areas 77c and 77d), the more difficult it can be to fit the second outer circumferential portion 770b into the second support portion 59 of the second housing 53. On the other hand, it can be made easier to fit the second outer circumferential portion 770b into the second support portion 59 of the second housing 53 by making the curvatures of the third and the fourth curved areas 77c and 77d smaller (in other words, by making the radius of curvatures of the third and the fourth curved areas 77c and 77d greater).

Meanwhile, with respect to the first outer circumferential portion 770a, it is possible to make the switch plate 62 difficult to come off from the first housing 52 in the semifixed state by making the curvatures of the first and the second curved areas 77a and 77b relatively great.

Furthermore, the outer circumference 770 of the flange 77 includes the first linear area 77e and the second linear area 77f that are parallel to the fitting direction Din. This makes the switch plate 62 more difficult to come off from the first housing 52. The following is a supplementary explanation of this effect. In the second embodiment, the circuit board 65 is fixed to the switch plate 62. On the circuit board 65, not only the switch circuit 63, but also the controller 260 is integrated. It means that the switch plate 62 supports the circuit board 65 at its lower portion. In other words, the switch plate 62 supports the circuit board 65 on its underside. Moreover, the switch plate 62 is situated at a position on the circuit board 65 that is distanced from the center (or center of gravity) of the circuit board 65. Thus, in the semifixed state, a load applied to the first support portion 58 of the first housing 52 from the switch plate 62 varies depending on the position of the first support portion 58. Specifically, a load applied from the switch plate 62 is greater in an area of the first support portion 58 close to the front thereof than in an area of the first support portion 58 close to the rear thereof. Such an imbalance in load may reduce the stability of the switch plate 62 in the semifixed state.

In this regards, in the second embodiment, a half or more than half of each of the first linear area 77e and the second linear area 77f are fitted into the first support portion 58 in the semifixed state. This inhibits the switch plate 62 from coming off from the first support portion 58.

### 2-3. Third Embodiment

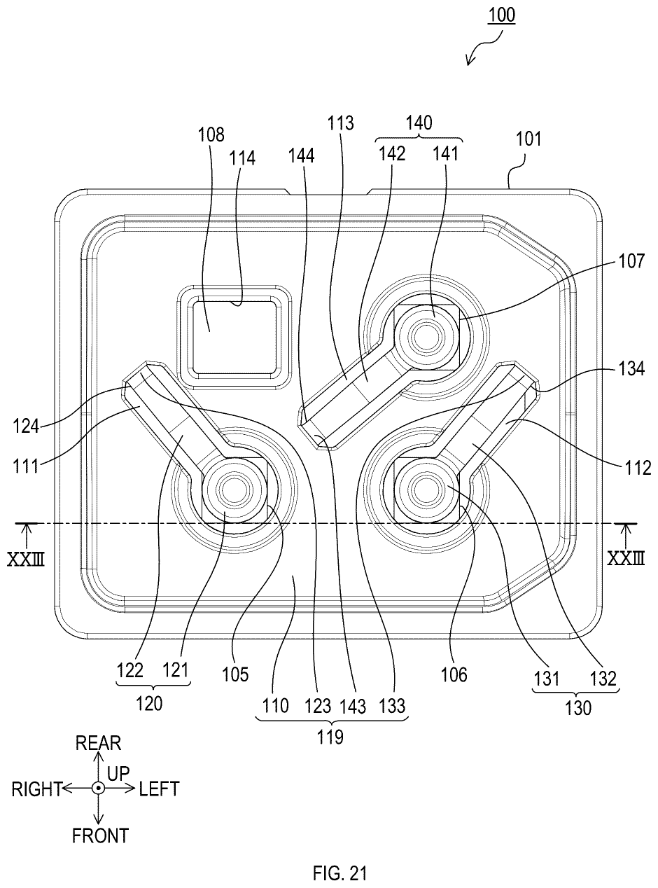

Another form of the switch unit will be explained with reference to FIG. 21 to FIG. 24. A switch unit 100 in the third embodiment can be used in various job-site electric devices in the same manner as the switch unit 10 in the first embodiment and the switch unit 60 in the second embodiment. In other words, in the first embodiment and the second embodiment, the switch unit 100 in the third embodiment can be used in place of the switch unit 10 and the switch unit 60.

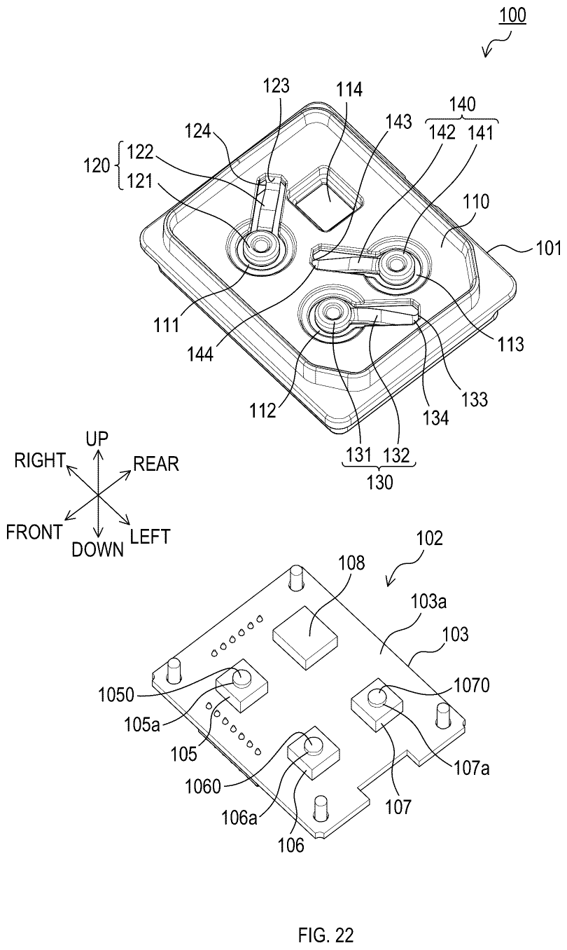

As shown in FIG. 22, the switch unit 100 includes a switch circuit 102. The switch circuit 102 includes a first switch 105, a second switch 106, a third switch 107, and a display 108.

The switch circuit 102 includes a circuit board 103. The first switch 105, the second switch 106, the third switch 107, and the display 108 are mounted on a board surface 103a of the circuit board 103.

The first switch 105 is the same component as the first switch 66 in the second embodiment, and the second switch 106 is the same component as the second switch 67 in the second embodiment. The third switch 107 is also the same component as the first switch 66 or the second switch 67 in the second embodiment (and thus the same component as the switch 15 in the first embodiment).

In other words, the first switch 105 includes a first movable piece 105a on its upper portion. The first movable piece 105a includes a switch surface 1050. The first movable piece 105a is manually moved downward via a first manually operating member 120 which will be explained below.

The second switch 106 includes a second movable piece 106a on its upper portion. The second movable piece 106a includes a switch surface 1060. The second movable piece 106a is manually moved downward via a second manually operating member 130 which will be explained below.

The third switch 107 includes a third movable piece 107a on its upper portion. The third movable piece 107a includes a switch surface 1070. The switch surface 1070 corresponds to an upper surface of the third movable piece 107a. The switch surface 1070 comes in contact with a third operating portion 141. The third operating portion 141 corresponds to the operating portion 31 in the first embodiment. The third movable piece 107a (specifically, the switch surface 1070) is configured to move in the downward direction and electrically turn on the third switch 107 in response to receiving the third load in the downward direction. The third load may be a load of any magnitude. In the third embodiment, the third load is the same as the first load and/or the second load.

The switch unit 100 includes a switch plate 101. The switch plate 101 has a plate-like overall shape. More specifically, the switch plate 101 has a thin tray-like shape including a partial opening. It is merely an example, but the switch plate 101 is an integrally molded member. In other words, the parts included in the switch plate 101 which will be explained below are integrally molded. The switch plate 101 may be a resin molded product that includes resin as its main component. The switch plate 101 is fixed to the circuit board 103 by screws.

The switch plate 101 includes the first manually operating member 120, the second manually operating member 130, and a third manually operating member 140.

The first manually operating member 120 basically has the same shape, structure, and size as the first manually operating member 80 in the second embodiment, except that the length of a first arm 122 is slightly longer than the first arm 82, and functions in the same manner as the first manually operating member 80.

The second manually operating member 130 and the third manually operating member 140 have the same shape, structure, and size as the first manually operating member 120 and function in the same manner as the first manually operating member 120.

The switch plate 101 includes a support body 119 (see FIG. 21). The support body 119 supports the first to the third manually operating members 120, 130, and 140.

The support body 119 includes a support member 110. The support member 110 has a plate-like shape. The support member 110 includes a first opening 111, a second opening 112, a third opening 113, and a fourth opening 114 that are open in the up-down directions. The first manually operating member 120 is situated in the first opening 111. The second manually operating member 130 is situated in the second opening 112. The third manually operating member 140 is situated in the third opening 113. The display 108 is situated away from the fourth opening 114 in the downward direction. When the switch plate 101 is viewed from outside in the downward direction, the display 108 can be visually recognized through the fourth opening 114.

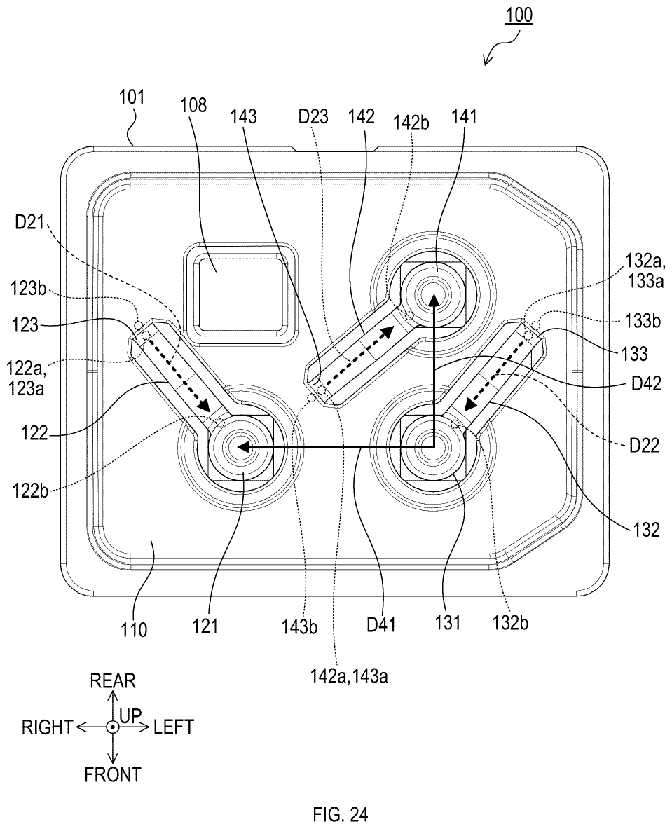

The support body 119 includes a first auxiliary arm 123, a second auxiliary arm 133, and a third auxiliary arm 143. These first to the third auxiliary arms 123, 133, and 143 have the same shape, structure, and size as the first auxiliary arm 83 in the second embodiment and function in the same manner as the first auxiliary arm 83. In other words, as shown in FIG. 24, the first auxiliary arm 123 includes a first end 123a and a second end 123b, and the second end 123b is coupled to the support member 110. The second auxiliary arm 133 includes a first end 133a and a second end 133b, and the second end 133b is coupled to the support member 110. The third auxiliary arm 143 includes a first end 143a and a second end 143b, and the second end 143b is coupled to the support member 110.

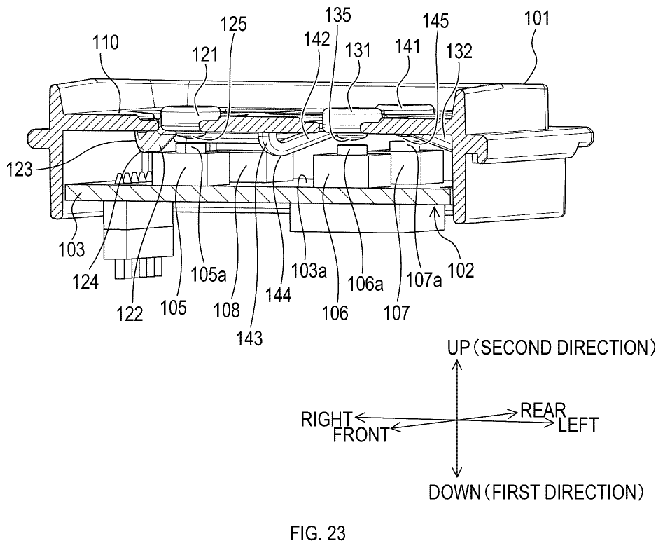

The first manually operating member 120 includes a first operating portion 121. The first operating portion 121 basically has the same shape, structure, and size as the first operating portion 81 in the second embodiment and functions in the same manner as the first operating portion 81. The first operating portion 121 is situated away from the first movable piece 105a in the upward direction. The first operating portion 121 includes a contact portion 125 in its lower end (see FIG. 23). In response to the first operating portion 121 being pressed downward, the contact portion 125 comes in contact with the switch surface 1050 of the first movable piece 105a and presses the switch surface 1050.

The first manually operating member 120 includes the first arm 122. The first arm 122 basically functions in the same manner as the first arm 82 in the second embodiment although its length is slightly different from the length of the first arm 82. As shown in FIG. 24, a first end 122a of the first arm 122 is coupled to the first end 123a of the first auxiliary arm 123. A second end 122b of the first arm 122 is coupled to the first operating portion 121.

The second manually operating member 130 includes a second operating portion (or a second button) 131. The second operating portion 131 has the same shape, structure, and size as the first operating portion 121 and functions in the same manner as the first operating portion 121. The second operating portion 131 is situated away from the second movable piece 106a in the upward direction. The second operating portion 131 includes a contact portion 135 in its lower end (see FIG. 23). In response to the second operating portion 131 being pressed downward, the contact portion 135 comes in contact with the switch surface 1060 of the second movable piece 106a and presses the switch surface 1060.

The second manually operating member 130 includes a second arm 132. The second arm 132 has the same shape, structure, and size as the first arm 122 and functions in the same manner as the first arm 122. As shown in FIG. 24, a first end 132a of the second arm 132 is coupled to the first end 133a of the second auxiliary arm 133. A second end 132b of the second arm 132 is coupled to the second operating portion 131.

The third manually operating member 140 includes a third arm 142. The third arm 142 has the same shape, structure, and size as the first arm 122 and functions in the same manner as the first arm 122. As shown in FIG. 24, a first end 142a of the third arm 142 is coupled to the first end 143a of the third auxiliary arm 143. A second end 142b of the third arm 142 is coupled to the third operating portion 141.

The switch plate 101 is an integrally molded member. Thus, the first to the third manually operating members 120, 130, and 140, the first to the third auxiliary arms 123, 133, and 143, and the support member 110 are integrally molded. This integrally molded member includes a first bent portion 124, a second bent portion 134, and a third bent portion 144. The first bent portion 124 is a portion that is bent into a U-shape and including a boundary between the first arm 122 and the first auxiliary arm 123. The second bent portion 134 is a portion that is bent into a U-shape and including a boundary between the second arm 132 and the second auxiliary arm 133. The third bent portion 144 is a portion that is bent into a U-shape and including a boundary between the third arm 142 and the third auxiliary arm 143.

In the third embodiment, a first reference plane, a second reference plane, and a third reference plane are defined. Similarly to the first reference plane PL11 in the second embodiment, the first reference plane is an imaginary plane that (i) is perpendicular to the downward direction and (ii) passes through the second end 122b of the first arm 122. The second reference plane is an imaginary plane that (i) is perpendicular to the downward direction and (ii) passes through the second end 132b of the second arm 132. The third reference plane is an imaginary plane that (i) is perpendicular to the downward direction and (ii) passes through the second end 142b of the third arm 142. In the third embodiment, the first to the third reference planes coincide with each other. Thus, the first to the third reference planes are simply referred to as the “reference planes”also in the third embodiment.

The first end 122a of the first arm 122 is situated away from the reference planes in the downward direction in the third initial state. The third initial state is a state in which the first to the third manually operating members 120, 130, and 140 are not manually moved. In the third initial state, the first arm distal-end distance is greater than or equal to the first switch surface distance. The first arm distal-end distance is a distance from the reference planes to the first end 122a of the first arm 122 (or to the lower edge of the first end 122a). The first switch surface distance is a distance from the reference planes to the switch surface 1050 of the first movable piece 105a.

In the third initial state, the second arm distal-end distance is greater than or equal to the second switch surface distance. The second arm distal-end distance is a distance from the reference planes to the first end 132a of the second arm 132 (or to the lower edge of the first end 132a). The second switch surface distance is a distance from the reference planes to the switch surface 1060 of the second movable piece 106a.

In the third initial state, a third arm distal-end distance is greater than or equal to a third switch surface distance. The third arm distal-end distance is a distance from the reference planes to the first end 142a of the third arm 142 (or to the lower edge of the first end 142a). The third switch surface distance is a distance from the reference planes to the switch surface 1070 of the third movable piece 107a.

The relationship between the first angle α2 and the second angle β2 in the second embodiment is applied in the same manner to each of the first to the third manually operating members 120, 130, and 140 in the third embodiment.

The relationship between the first spring constant and the second spring constant in the second embodiment is also applied in the same manner to each of the first to the third manually operating members 120, 130, and 140 in the third embodiment.

The magnitude relationship between various distances in the direction along the reference planes in the second embodiment is also applied in the same manner to each of the first to the third manually operating members 120, 130, and 140 in the third embodiment.

Thus, following is an explanation with respect to the third manually operating member 140 for example. If the third operating portion 141 is pressed in the downward direction, the third operating portion 141 is displaced in the downward direction together with the third arm 142 about the third bent portion 144 as the fulcrum. In other words, the third bent portion 144 is elastically deformed, and thereby the third manually operating member 140 is displaced in the downward direction.

As it is shown in FIG. 17 for the second embodiment, the contact portion 145 of the third operating portion 141 (see FIG. 23) comes in contact with the switch surface 1070 of the third movable piece 107a, and thereby the third load is applied to the third movable piece 107a from the third operating portion 141. This causes the third movable piece 107a to move downward to turn on the third switch 107.

Further characteristics of the third embodiment are explained below.

In the third embodiment, the first operating portion 121, the second operating portion 131, and the third operating portion 141 are not on a same straight line. Specifically, as shown in FIG. 24, an angle formed between a first separation direction D41 and a second separation direction D42 is greater than or equal to 80° and less than or equal to 100°. This angle may be 90°.

The first separation direction D41 is a direction from the second operating portion 131 toward the first operating portion 121 when the switch plate 101 is viewed from outside in the downward direction. In other words, the first separation direction D41 is a component of a direction parallel to the reference planes in a direction from the second operating portion 131 toward the first operating portion 121. The second separation direction D42 is a direction from the second operating portion 131 toward the third operating portion 141 when the switch plate 101 is viewed from outside in the downward direction. In other words, the second separation direction D42 is a component of a direction parallel to the reference planes in a direction from the second operating portion 131 toward the third operating portion 141. In FIG. 24, the reference planes are surfaces that are parallel to the paper surface of FIG. 24.

At least two of a first extension-starting direction D21 of the first arm 122, a second extension-starting direction D22 of the second arm 132, and a third extension-starting direction D23 of the third arm 142 are different from each other.

The first extension-starting direction D21 is a direction in which the first arm 122 extends from the first end 122a when the first arm 122 is viewed from outside in the downward direction. In other words, the first extension-starting direction D21 is a component of a direction parallel to the reference planes in a direction in which the first arm 122 extends from the first end 122a (more specifically, toward the second end 122b in the third embodiment).

The second extension-starting direction D22 is a direction in which the second arm 132 extends from the first end 132a when the second arm 132 is viewed from outside in the downward direction. In other words, the second extension-starting direction D22 is a component of a direction parallel to the reference planes in a direction in which the second arm 132 extends from the first end 132a (more specifically, toward the second end 132b in the third embodiment).

The third extension-starting direction D23 is a direction in which the third arm 142 extends from the first end 142a when the third arm 142 is viewed from outside in the downward direction. In other words, the third extension-starting direction D23 is a component of a direction parallel to the reference planes in a direction in which the third arm 142 extends from the first end 142a (more specifically, toward the second end 142b in the third embodiment).

In the third embodiment, the first extension-starting direction D21, the second extension-starting direction D22, and the third extension-starting direction D23 are different from each other. Specifically, an angle formed between the second extension-starting direction D22 and the third extension-starting direction D23 is greater than or equal to 170° and less than or equal to 180°. This angle may be 180°. The first extension-starting direction D21 is not parallel to the second extension-starting direction D22 and the third extension-starting direction D23. However, these are merely examples, and each of the first extension-starting direction D21, the second extension-starting direction D22, and the third extension-starting direction D23 may be determined in any manner.

In the third embodiment, the display 108 is situated away from the second switch 106 in the third separation direction. The third separation direction is a direction resultant from a combination of the first separation direction D41 and the second separation direction D42. Now, an imaginary parallelogram is defined. This parallelogram includes four vertices. Out of the four vertices, three vertices are individually present in the first operating portion 121, the second operating portion 131, and the third operating portion 141. This parallelogram is parallel to the reference planes. At this time, the remaining vertex of the four vertices may be present in the display 108.

### 2-4. Fourth Embodiment

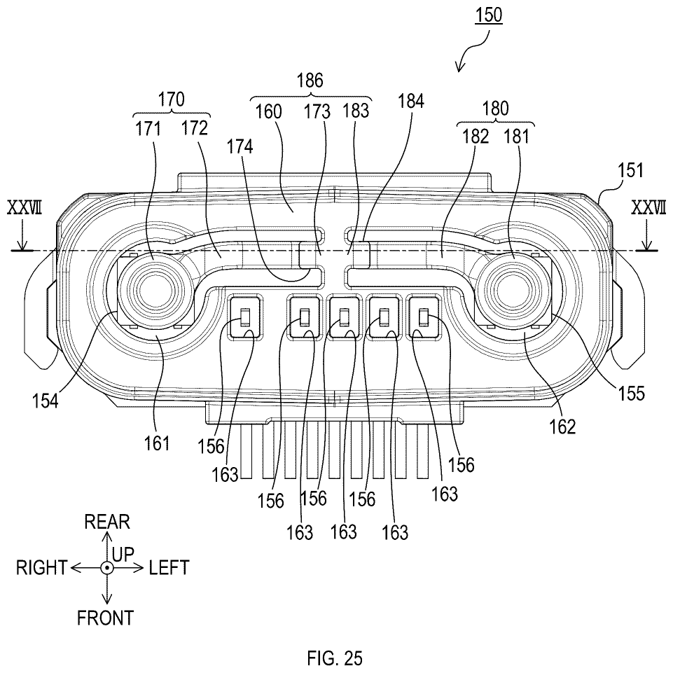

Another form of the switch unit will be described below with reference to FIG. 25 to FIG. 28. A switch unit 150 of the fourth embodiment can be used in various job-site electric devices in the same manner as the switch unit 10 in the first embodiment, the switch unit 60 in the second embodiment, and the switch unit 100 in the third embodiment. In other words, in the first to the third embodiment, the switch unit 150 of the fourth embodiment can be used in place of the switch units 10, 60, and 100.

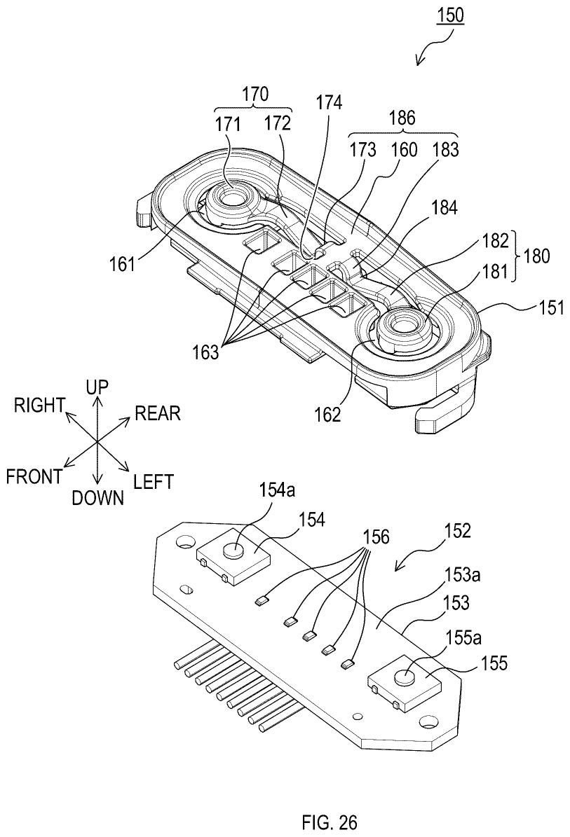

As shown in FIG. 26, the switch unit 150 includes a switch circuit 152. The switch circuit 152 includes a first switch 154, a second switch 155, and at least two light emitters 156.

The switch circuit 152 includes a circuit board 153. The first switch 154, the second switch 155, and the at least two light emitters 156 are mounted on a board surface 153a of the circuit board 153.

Each of the first and the second switches 154 and 155 are the same component as the switch 15 in the first embodiment. In other words, the first switch 154 includes a first movable piece 154a on its upper portion. The second switch 155 includes a second movable piece 155a on its upper portion.

The switch unit 150 includes a switch plate 151. The switch plate 151 is an integrally molded member. The switch plate 151 has a plate-like overall shape. More specifically, the switch plate 151 has a thin tray-like shape including a partial opening. It is merely an example, but the switch plate 151 is an integrally molded member. In other words, the parts included in the switch plate 151 which will be explained below are integrally formed. The switch plate 151 may be a resin molded product that includes resin as its main component. The switch plate 151 is fixed to the circuit board 153 by screws.

The switch plate 151 includes a first manually operating member 170 and a second manually operating member 180. The first and the second manually operating members 170 and 180 basically have the same shape, structure, and size as the manually operating member 30 in the first embodiment and function in the same manner as the manually operating member 30 except that lengths of portions of the first and the second manually operating members 170 and 180 corresponding to the initial portion 321 in the first embodiment (see FIG. 6) are longer than the initial portion 321.

The switch plate 151 includes a support body 186. The support body 186 supports the first and the second manually operating members 170 and 180. The support body 186 includes a support member 160. The support member 160 has a plate-like shape. The support member 160 includes a first opening 161, a second opening 162, and at least two third openings 163 that are open in the up-down directions. The first manually operating member 170 is situated in the first opening 161. The second manually operating member 180 is situated in the second opening 162. Each of the light emitters 156 are situated away from a corresponding one of the at least two third openings 163 in the downward direction.

The support body 186 includes a first auxiliary arm 173 and a second auxiliary arm 183. These first and second auxiliary arms 173 and 183 have the same shape, structure, and size as the auxiliary arm 33 in the first embodiment and function in the same manner as the auxiliary arm 33. In other words, the first auxiliary arm 173 includes a first end 173a and a second end 173b, and the second end 173b is coupled to the support member 160. The second auxiliary arm 183 includes a first end 183a and a second end 183b, and the second end 183b is coupled to the support member 160.

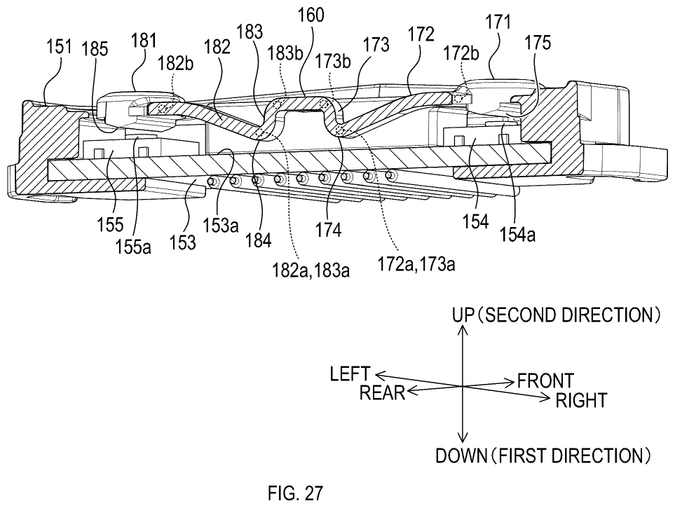

The first manually operating member 170 includes a first operating portion 171. The first operating portion 171 has the same shape, structure, and size as the operating portion 31 in the first embodiment and functions in the same manner as the operating portion 31. The first operating portion 171 is situated away from the first movable piece 154a in the upward direction. The first operating portion 171 includes a contact portion 175 in its lower end (see FIG. 27).

The first manually operating member 170 includes a first arm 172. The first arm 172 basically functions in the same manner as the arm 32 in the first embodiment except that the length of the first arm 172 is slightly different from the length of the arm 32. A first end 172a of the first arm 172 is coupled to the first end 173a of the first auxiliary arm 173.

The second manually operating member 180 includes a second operating portion 181. The second operating portion 181 is situated away from the second movable piece 155a in the upward direction. The second operating portion 181 includes a contact portion 185 in its lower end (see FIG. 27).

The second manually operating member 180 includes a second arm 182. The second arm 182 has the same shape, structure, and size as the first arm 172 and functions in the same manner as the first arm 172. A first end 182a of the second arm 182 is coupled to the first end 183a of the second auxiliary arm 183.

The switch plate 151 includes a first bent portion 174 and a second bent portion 184. The first bent portion 174 is a portion that is bent into a U-shape and including a boundary between the first arm 172 and the first auxiliary arm 173. The second bent portion 184 is a portion that is bent into a U-shape and including a boundary between the second arm 182 and the second auxiliary arm 183.

A reference plane is also defined in the fourth embodiment. The reference plane is an imaginary plane that (i) is perpendicular to the downward direction and (ii) passes through a second end 172b of the first arm 172 and a second end 182b of the second arm 182. The first end 172a of the first arm 172 and the first end 182a of the second arm 182 are situated away from the reference plane in the downward direction in the initial state.

The relationship between the arm distal-end distance and the switch surface distance in the first embodiment is applied in the same manner to the relationship between the first manually operating member 170 and the first movable piece 154a and the relationship between the second manually operating member 180 and the second movable piece 155a in the fourth embodiment.

The relationship between the first angle α1 and the second angle β1 in the first embodiment is applied in the same manner to each of the first and the second manually operating members 170 and 180 in the fourth embodiment.

The relationship between the first spring constant and the second spring constant in the first embodiment is applied in the same manner to each of the first and the second manually operating members 170 and 180 in the fourth embodiment.

The magnitude relationship between the various distances in a direction along the reference plane in the first embodiment is also applied in the same manner to each of the first and the second manually operating members 170 and 180 in the fourth embodiment.

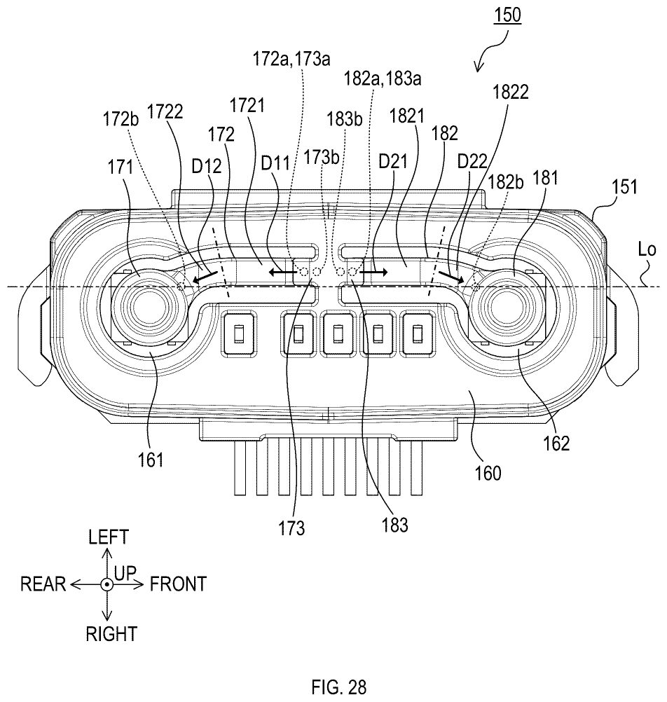

Further characteristics of the fourth embodiment are explained below with reference to FIG. 28.

The first arm 172 includes a first initial portion 1721. The first initial portion 1721 corresponds to a portion of the first arm 172 that extends from the first end 172a of the first arm 172 in a first extension-starting direction D11. The first extension-starting direction D11 is a direction that extends from the first end 172a when the first arm 172 is viewed from outside in the downward direction. In other words, the first extension-starting direction D11 is a component of a direction that is parallel to the reference plane in a direction in which the first arm 172 extends from the first end 172a. In FIG. 28, the reference plane is a surface that is parallel to the paper surface of FIG. 28.

The first arm 172 further includes a first continuing portion 1722. The first continuing portion 1722 corresponds to a portion of the first arm 172 that extends from an edge of the first initial portion 1721 in a first extension-continuing direction D12. The first extension-continuing direction D12 is a direction that extends from the edge of the first initial portion 1721 (that is, an end portion opposite to the first end 172a) when the first arm 172 is viewed from outside in the downward direction. In other words, the first extension-continuing direction D12 is a component of a direction parallel to the reference plane in a direction in which the first continuing portion 1722 extends from the first initial portion 1721. The first extension-continuing direction D12 is different from the first extension-starting direction D11.

Similarly, the second arm 182 includes a second initial portion 1821. The second initial portion 1821 corresponds to a portion of the second arm 182 that extends from the first end 182a of the second arm 182 in a second extension-starting direction D21. The second extension-starting direction D21 is a direction that extends from the first end 182a when the second arm 182 is viewed from outside in the downward direction. In other words, the second extension-starting direction D21 is a component of a direction parallel to the reference plane in a direction in which the second arm 182 extends from the first end 182a.

The second arm 182 further includes a second continuing portion 1822. The second continuing portion 1822 corresponds to a portion of the second arm 182 that extends from an edge of the second initial portion 1821 in a second extension-continuing direction D22. The second extension-continuing direction D22 is a direction that extends from the edge of the second initial portion 1821 (that is, an end portion opposite to the first end 182a) when the second arm 182 is viewed from outside in the downward direction. In other words, the second extension-continuing direction D22 is a component of a direction parallel to the reference plane in a direction in which the second continuing portion 1822 extends from the second initial portion 1821. The second extension-continuing direction D22 is different from the second extension-starting direction D21.

Furthermore, both of the first continuing portion 1722 and the second continuing portion 1822 extend toward an imaginary straight line Lo. The imaginary straight line Lo is a virtual straight line that passes through the second end 172b of the first arm 172 and the second end 182b of the second arm 182.

The first arm 172 extends from the first end 172a of the first arm 172 in a direction away from the first end 182a of the second arm 182. The second arm 182 extends from the first end 182a of the second arm 182 in a direction away from the first end 172a of the first arm 172.

An angle formed between the first extension-starting direction D11 and the second extension-starting direction D21 is greater than 170° and less than or equal to 180°. This angle may be 180°.

### 2-5. Other Embodiments

Although the embodiments of the present disclosure have been explained above, the present disclosure can be implemented in various modifications without being limited to the aforementioned embodiments.

In each of the aforementioned embodiments, the switch unit includes the bent portion. However, it is not always necessary that the switch unit includes the bent portion.

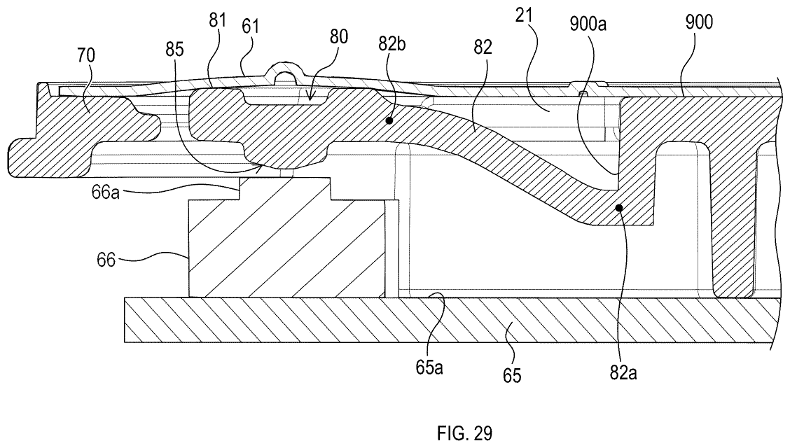

FIG. 29 shows an example of a switch unit that does not include a bent portion. FIG. 29 corresponds to a cross-sectional view taken along a line XVI-XVI of FIG. 14 in the second embodiment. In FIG. 29, elements which are the same as the elements in the second embodiment are given the same reference numbers.

In FIG. 29, a support member 900 includes a rib 900a. The rib 900a extends downward from an edge of the first opening 21. The width (a length in a direction perpendicular to the paper surface of FIG. 29) of the rib 900a is greater than the width of the first arm 82. The width of the rib 900a may be appropriately determined.

The first arm 82 extends from a lower end of the rib 900a. In other words, the first end 82a of the first arm 82 is present at the lower end of the rib 900a.

With respect to properly pressing the first movable piece 66a, the same effect as in the second embodiment can be obtained also in such a configuration.

The first end 82a of the first arm 82 may be supported by a member of any kind. The first arm 82 may be supported by a support member that is in a form different from the auxiliary arms of the aforementioned embodiments or the rib 900a in FIG. 29.

### 2-6. Supplementation

Two or more functions achieved by one element in the aforementioned embodiments may be achieved by two or more elements, and one function achieved by one element in the aforementioned embodiments may be achieved by two or more elements. In addition, two or more functions achieved by two or more elements may be achieved by one element, and one function achieved by two or more elements may be achieved by one element. A part of the configurations of the aforementioned embodiments may be omitted. Furthermore, at least a part of the configurations of the aforementioned embodiments may be added to or replaced with another configuration of the aforementioned embodiments.

What is claimed is:

1. A job-site electric device comprising:
a first switch including a first movable piece, the first movable piece being configured to move in a first direction in response to receiving a first load in the first direction;
a first manually operating member including:
a first operating portion (i) situated away from the first movable piece in a second direction that is opposite to the first direction, and (ii) configured to be displaced in the first direction in response to being manually moved in the first direction and thereby applying a first load to the first movable piece; and
a first arm including a first end and a second end, the second end being coupled to the first operating portion, the first end being situated away from a first reference plane in the first direction in a first initial state, the first initial state corresponding to a state in which the first manually operating member is not manually moved, and the first reference plane being an imaginary plane that is perpendicular to the first direction and that passes through the second end; and
a support body to which the first end of the first arm is coupled and thereby supporting the first manually operating member.

2. The job-site electric device according to claim 1,
wherein the first movable piece includes a switch surface (i) corresponding to a surface of the first movable piece and (ii) configured to receive the first load from the first operating portion in response to the first operating portion contacting the switch surface,
wherein an arm distal-end distance is greater than or equal to a switch surface distance, the arm distal-end distance being a distance from the first reference plane to the first end of the first arm along the first direction in the first initial state, the switch surface distance being a distance from the first reference plane to the switch surface along the first direction in the first initial state.

3. The job-site electric device according to claim 1,
wherein the first manually operating member is configured to be displaced in the first direction about the first end as a fulcrum in response to the first operating portion being manually moved in the first direction.

4. The job-site electric device according to claim 1,
wherein the first arm includes:
a first initial portion extending from the first end of the first arm in a first extension-starting direction which is perpendicular to the first direction, and
a first continuing portion extending from an edge of the first initial portion in a first extension-continuing direction, the first extension-continuing direction being perpendicular to the first direction and being different from the first extension-starting direction.

5. The job-site electric device according to claim 1,
wherein the first arm includes a width and a thickness,
wherein the width is a length in a direction perpendicular to a direction in which the first arm extends and that is parallel to the first reference plane,
wherein the thickness is a length in a direction perpendicular to a direction in which the first arm extends and that is perpendicular to the width, and
wherein the width is at least twice the thickness.

6. The job-site electric device according to claim 1,
wherein the support body includes a first opening that is open in the first direction, and
wherein the first manually operating member is situated in the first opening,
the job-site electric device further comprising:
a light emitter (i) situated away from the first opening in the first direction and (ii) configured to emit light through the first opening.

7. The job-site electric device according to claim 1,
wherein the support body includes a first auxiliary arm (i) extending from the first end of the first arm in a direction approaching the first reference plane, and (ii) including a first auxiliary end and a second auxiliary end, and
wherein the first auxiliary end is coupled to the first end of the first arm.

8. The job-site electric device according to claim 7,
wherein the first arm has a first planar distance, the first planar distance being a distance from the first end of the first arm to the second end of the first arm in a direction parallel to the first reference plane,
wherein the first auxiliary arm has a second planar distance, the second planar distance being a distance from the first auxiliary end of the first auxiliary arm to the second auxiliary end of the first auxiliary arm in a direction parallel to the first reference plane, and
wherein the first planar distance is longer than the second planar distance.

9. The job-site electric device according to claim 7,
wherein the first arm has a first angle, the first angle being (i) an angle formed between the first reference plane and a main extension direction, the main extension direction being a direction from the first end of the first arm to the second end of the first arm, and (ii) less than 90°, and
wherein the first auxiliary arm has a second angle, the second angle being (i) an angle formed between the first reference plane and an auxiliary extension direction, the auxiliary extension direction being a direction from the first auxiliary end of the first auxiliary arm to the second auxiliary end of the first auxiliary arm, and (ii) less than 90°, and
wherein the first angle is less than the second angle.

10. The job-site electric device according to claim 7, further comprising:
an integrally molded member (i) including the first arm, the first auxiliary arm, and a bent portion, and (ii) being in a form of a single member, and
wherein the bent portion (i) is at a border between the first arm and the first auxiliary arm, (ii) corresponds to a portion of the integrally molded member that is bent, and (iii) is configured to be elastically deformed in response to the first operating portion being manually moved in the first direction and thereby cause the first operating portion to be displaced in the first direction.

11. The job-site electric device according to claim 10,
wherein the support body includes a support member,
wherein the second auxiliary end of the first auxiliary arm is integrally coupled to the support member and thereby the support member supports the first manually operating member via the first auxiliary arm,
wherein the first auxiliary arm is configured to be elastically deformable about the second auxiliary end as a fulcrum,
wherein the second auxiliary end of the first auxiliary arm has a first spring constant, the first spring constant showing difficulty in elastic deformation of the second auxiliary end,
wherein the bent portion has a second spring constant, the second spring constant showing difficulty in elastic deformation of the bent portion, and
wherein the first spring constant is greater than the second spring constant.

12. The job-site electric device according to claim 1, further comprising:
a second switch including a second movable piece, the second movable piece being configured to move in the first direction in response to receiving a second load in the first direction; and
a second manually operating member including:
a second operating portion (i) situated away from the second movable piece in the second direction, and (ii) configured to be displaced in the first direction in response to being manually moved in the first direction and thereby apply the second load to the second movable piece, and
a second arm including a first end and a second end, the second end of the second arm being coupled to the second operating portion, the first end of the second arm being situated away from a second reference plane in the first direction in a second initial state, the second initial state corresponding to a state in which the second manually operating member is not manually moved, and the second reference plane being an imaginary plane that is perpendicular to the first direction and that passes through the second end of the second arm.

13. The job-site electric device according to claim 12,
wherein the first arm extends from the first end of the first arm in a direction away from the first end of the second arm, and
wherein the second arm extends from the first end of the second arm in a direction away from the first end of the first arm.

14. The job-site electric device according to claim 13,
wherein an angle formed between a first extension-starting direction of the first arm and a second extension-starting direction of the second arm is greater than 170° and less than or equal to 180°,
wherein the first extension-starting direction is a direction in which the first arm extends from the first end of the first arm and that is perpendicular to the first direction, and
wherein the second extension-starting direction is a direction in which the second arm extends from the first end of the second arm and that is perpendicular to the first direction.

15. The job-site electric device according to claim 14,
wherein the first arm includes:
a first initial portion extending from the first end of the first arm in the first extension-starting direction, and
a first continuing portion extending from an edge of the first initial portion in a first extension-continuing direction, the first extension-continuing direction being perpendicular to the first direction and different from the first extension-starting direction,
wherein the second arm includes:
a second initial portion extending from the first end of the second arm in the second extension-starting direction, and
a second continuing portion extending from an edge of the second initial portion in a second extension-continuing direction, the second extension-continuing direction being perpendicular to the first direction and different from the second extension-starting direction,
wherein both of the first continuing portion and the second continuing portion extend toward an imaginary straight line that passes through the second end of the first arm and the second end of the second arm.

16. The job-site electric device according to claim 12, further comprising:
a third switch including a third movable piece, the third movable piece being configured to move in the first direction in response to receiving a third load in the first direction, and
a third manually operating member including:
a third operating portion (i) situated away from the third movable piece in the second direction, and (ii) configured to be displaced in the first direction in response to being manually moved in the first direction and thereby apply the third load to the third movable piece, and
a third arm including a first end and a second end, the first end of the third arm being situated away from a third reference plane in the first direction in a third initial state, the third initial state corresponding to a state in which the third manually operating member is not manually moved, and the third reference plane being an imaginary plane that is perpendicular to the first direction and that passes through the second end of the third arm,
wherein the first operating portion, the second operating portion, and the third operating portion are not aligned on a same straight line.

17. The job-site electric device according to claim 16,
wherein an angle formed between a first separation direction and a second separation direction is greater than or equal to 80° and less than or equal to 100°,
wherein the first separation direction is a direction from the second operating portion to the first operating portion and is perpendicular to the first direction,
wherein the second separation direction is a direction from the second operating portion to the third operating portion and is perpendicular to the first direction.

18. The job-site electric device according to claim 17, further comprising:
a display (i) situated away from the second switch in a third separation direction, and (ii) configured to display information related to operation of the job-site electric device, and the third separation direction being a direction resultant from a combination of the first separation direction and the second separation direction.

19. The job-site electric device according to claim 16,
wherein at least two of a first extension-starting direction of the first arm, a second extension-starting direction of the second arm, or a third extension-starting direction of the third arm are different from one another,
wherein the first extension-starting direction is a direction in which the first arm extends from the first end of the first arm and is perpendicular to the first direction,
wherein the second extension-starting direction is a direction in which the second arm extends from the first end of the second arm and is perpendicular to the first direction, and
wherein the third extension-starting direction is a direction in which the third arm extends from the first end of the third arm and is perpendicular to the first direction.

20. The job-site electric device according to claim 19,
wherein the first extension-starting direction, the second extension-starting direction, and the third extension-starting direction are different from one another.

21. The job-site electric device according to claim 19,
wherein an angle formed between the second extension-starting direction and the third extension-starting direction is greater than or equal to 170° and less than or equal to 180°.

22. The job-site electric device according to claim 19,
wherein the first extension-starting direction is nonparallel to the second extension-starting direction and the third extension-starting direction.

23. The job-site electric device according to claim 1, further comprising:
a housing (i) housing the first switch, and (ii) including a first housing and a second housing that are combined with each other,
wherein the support body (i) has a plate-like shape, and (ii) includes an outer circumference,
wherein the first housing includes a first support portion that supports the support body such that a first outer circumferential portion of the support body is fitted into the first support portion, the first outer circumferential portion being a first portion of the outer circumference,
wherein the second housing includes a second support portion that supports the support body such that a second outer circumferential portion of the support body is fitted into the second support portion, the second outer circumferential portion being a second portion of the outer circumference and different from the first outer circumferential portion, and
wherein a shape of the second outer circumferential portion is different from a shape of the first outer circumferential portion.

24. The job-site electric device according to claim 23,
wherein, in an unassembled state, the support body is configured to be fitted into the first support portion in a given fitting direction, and
wherein the unassembled state is a state in which the support body is not assembled to the housing and in which the second housing is situated away from the first housing.

25. The job-site electric device according to claim 24,
wherein the outer circumference of the support body includes a first linear area and a second linear area,
wherein the first linear area is a linear area that includes one of two borders between the first outer circumferential portion and the second outer circumferential portion, and
wherein the second linear area is a linear area that includes an other one of the two borders.

26. The job-site electric device according to claim 25,
wherein the first linear area and the second linear area are parallel to the fitting direction.

27. The job-site electric device according to claim 24,
wherein the first outer circumferential portion includes a first curved area that is curved and a second curved area that is curved,
wherein the second outer circumferential portion includes a third curved area that is curved and a fourth curved area that is curved,
wherein curvature of the first curved area is greater than curvature of the third curved area and curvature of the fourth curved area, and
wherein curvature of the second curved area is greater than the curvature of the third curved area and the curvature of the fourth curved area.

28. The job-site electric device according to claim 1, further comprising:
an electric load,
a control circuit configured to control the electric load, and
a circuit board (i) on which the control circuit is mounted, and (ii) to which the first switch and the support body are fixed.
